(19) United States
(12) Patent Application Publication
(10) Pub. No.: US 2026/0253543 A1
(43) Pub. Date: Aug. 27, 2026

(54) PIXEL CIRCUIT, DISPLAY DEVICE INCLUDING THE PIXEL CIRCUIT, AND ELECTRONIC DEVICE INCLUDING THE DISPLAY DEVICE

(71) Applicant: SAMSUNG DISPLAY CO., LTD., YONGIN-SI (KR)

(72) Inventors: JAEKEUN LIM, Yongin-si (KR); JIN-WOOK YANG, Yongin-si (KR)

(21) Appl. No.: 19/377,183

(22) Filed: Nov. 3, 2025

(30) Foreign Application Priority Data
Feb. 27, 2025 (KR) 10-2025-0026147

(51) Int. Cl. G09G 3/3233; G09G 3/32; G09G 3/3291

(52) U.S. Cl. CPC G09G 3/3233; G09G 3/32; G09G 3/3291; G09G 2300/0819; G09G 2300/0861; G09G 2320/0233; G09G 2320/045

(57) ABSTRACT

A display device includes a pixel circuit that sequentially performs a first compensation operation for compensating the threshold voltage variation of a driving transistor of the pixel circuit using a first reference voltage, the data write operation for the pixel circuit, and the second compensation operation for compensating the threshold voltage variation of the driving transistor using a second reference voltage different from the first reference voltage. The pixel circuit includes the driving transistor and a boosting capacitor. The driving transistor includes a gate electrode connected to an electrode of the boosting capacitor, a first electrode receiving a first power supply voltage, and a second electrode connected to an emission control transistor.

This application claims priority under 35 USC § 119 to Korean Patent Application No. 10-2025-0026147 filed on Feb. 27, 2025, in the Korean Intellectual Property Office (KIPO), the entire disclosure of which is incorporated by reference herein in its entirety.

### BACKGROUND

### 1. Field

Embodiments of the present inventive concept relates to a pixel circuit, a display device including the pixel circuit, and an electronic device including the display device.

### 2. Discussion of the Related Art

In general, a display device includes a display panel and a display panel driver. The display panel includes gate lines, data lines, emission lines, and pixels. The display panel driver includes a gate driver for providing a gate signal to the gate lines, a data driver for providing a data voltage to the data lines, an emission driver for providing an emission signal to the emission lines and a driving controller for controlling the gate driver, the data driver, and the emission driver.

Each of the pixels may operate on a frame-by-frame basis. For example, a frame period may include an initialization period, a compensation period, a data write period, and an emission period. The initialization period refers to a period in which a state of each of the pixels is initialized to ensure accurate and stable operation of the pixels. The compensation period refers to a period in which a threshold voltage of a driving transistor of the pixel is compensated for. The data write period refers to a period in which the data voltage is written to the pixel. The emission period refers to a period in which a light emitting element of the pixel emits a light.

Depending on a configuration of the pixel, an operation of the pixel may vary. For example, the compensation period and the data write period may not overlap in time. In such a case, each of the pixels may include two capacitors, one for compensating the threshold voltage of the driving transistor, and the other for holding the data voltage to be written into the pixel. When the two capacitors are designed separately in each of the pixels, additional masks or process steps may be used for fabricating the pixels, and may deteriorate productivity due to reduction in the PPI (Pitch Per Inch).

### SUMMARY

Embodiments of the present inventive concept provide a pixel circuit including a single capacitor for each pixel circuit.

Embodiments of the present inventive concept provide a display device including the pixel circuit.

Embodiments of the present inventive concept provide an electronic device including the display device.

In an embodiment of a pixel circuit according to the present inventive concept, the pixel circuit comprises a first transistor including a gate electrode connected to a first node, a first electrode connected to a first power supply voltage, and a second electrode connected to a second node, a second transistor including a gate electrode configured to receive a data write gate signal, a first electrode connected to a data line and configured to receive a data voltage through the data line, and a second electrode connected to a third node, a third transistor including a gate electrode configured to receive a compensation gate signal, a first electrode connected to the first node, and a second electrode connected to the second node, a fourth transistor including a gate electrode configured to receive an initialization gate signal, a first electrode connected to an initialization voltage, and a second electrode connected to the first node, a fifth transistor including a gate electrode configured to receive an emission signal, a first electrode connected to the second node, and a second electrode connected to a fourth node, a sixth transistor including a gate electrode configured to receive a first reset gate signal, a first electrode connected to a first reference voltage, and a second electrode connected to the third node, a seventh transistor including a gate electrode configured to receive a bias gate signal, a first electrode connected to the initialization voltage, and a second electrode connected to the fourth node, a storage capacitor including a first electrode connected to the third node and a second electrode connected to the first node, and a light emitting element including an anode electrode connected to the fourth node and a cathode electrode connected to a second power supply voltage.

In an embodiment, the first reference voltage is greater than or equal to a maximum value of the data voltage.

In an embodiment, the pixel circuit further includes an eighth transistor including a gate electrode configured to receive a second reset gate signal, a first electrode connected to a second reference voltage different from the first reference voltage, and a second electrode connected to the third node.

In an embodiment, the second reference voltage is lower than or equal to a maximum value of the data voltage.

In an embodiment, the first transistor, the second transistor, the third transistor, the fourth transistor, the fifth transistor, the sixth transistor, the seventh transistor, and the eighth transistor may be PMOS transistors.

In an embodiment, the first transistor, the second transistor, the fifth transistor, the sixth transistor, the seventh transistor, and the eighth transistor are PMOS transistors, and the third transistor and the fourth transistor may be NMOS transistors.

In an embodiment, in an initialization period, the fourth transistor is configured to be turned on to provide the initialization voltage to the first node, and the sixth transistor is configured to be turned on to provide the first reference voltage to the third node.

In an embodiment, in a first compensation period following the initialization period, the third transistor is configured to be turned on to diode-connect the first transistor, and the sixth transistor is configured to be turned on to provide the first reference voltage to the third node.

In an embodiment, in a second compensation/data write period following the first compensation period, the second transistor is configured to be turned on to provide the data voltage transmitted through the data line to the third node, the third transistor is configured to be turned on to diode-connect the first transistor, and the seventh transistor is configured to be turned on to provide the initialization voltage to the fourth node.

In an embodiment, in a data transmission period following the second compensation/data write period, the eighth transistor is configured to be turned on to provide the second reference voltage to the third node.

In an embodiment, in an emission period following the data transmission period, the first transistor is configured to be turned on based on a voltage of the first node and the first power supply voltage to generate a driving current, and the first transistor and the fifth transistor are configured to be turned on to provide the driving current to the light emitting element.

In an embodiment, the pixel circuit further includes an eighth transistor and a ninth transistor, wherein the eighth transistor includes a gate electrode configured to receive the data write gate signal, a first electrode connected to a second electrode of the ninth transistor, and a second electrode connected to the third node, and a ninth transistor includes a gate electrode configured to receive the first reset gate signal, a first electrode configured to receive a second reference voltage different from the first reference voltage, and the second electrode connected to the first electrode of the eighth transistor.

In an embodiment, the second reference voltage is lower than or equal to a maximum value of the data voltage.

In an embodiment, the first transistor, the second transistor, the fifth transistor, the sixth transistor, and the seventh transistor are PMOS transistors, and the third transistor, the fourth transistor, the eighth transistor, and the ninth transistor are NMOS transistors.

In an embodiment, in an initialization period, the fourth transistor is configured to be turned on to provide the initialization voltage to the first node, and the sixth transistor is configured to be turned on to provide the first reference voltage to the third node.

In an embodiment, in a first compensation period following the initialization period, the third transistor is configured to be turned on to diode-connect the first transistor, and the sixth transistor is configured to be turned on to provide the first reference voltage to the third node.

In an embodiment, in a second compensation/data write period following the first compensation period, the second transistor is configured to be turned on to provide the data voltage transmitted through the data line to the third node, the third transistor is configured to be turned on to diode-connect the first transistor, and the seventh transistor is configured to be turned on to provide the initialization voltage to the fourth node.

In an embodiment, in a data transmission period following the second compensation/data write period, the eighth transistor and the ninth transistor are configured to be turned on to provide the second reference voltage to the third node.

In an embodiment of a display device according to the present inventive concept, the display device comprises a display panel including a pixel circuit, and a display panel driver configured to drive the display panel, wherein the pixel circuit includes a first transistor including a gate electrode connected to a first node, a first electrode connected to a first power supply voltage, and a second electrode connected to a second node, a second transistor including a gate electrode configured to receive a data write gate signal, a first electrode connected to a data line and configured to receive a data voltage transmitted through the data line, and a second electrode connected to a third node, a third transistor including a gate electrode configured to receive a compensation gate signal, a first electrode connected to the first node, and a second electrode connected to the second node, a fourth transistor including a gate electrode configured to receive an initialization gate signal, a first electrode connected to an initialization voltage, and a second electrode connected to the first node, a fifth transistor including a gate electrode configured to receive an emission signal, a first electrode connected to the second node, and a second electrode connected to a fourth node, a sixth transistor including a gate electrode configured to receive a first reset gate signal, a first electrode connected to a first reference voltage, and a second electrode connected to the third node, a seventh transistor including a gate electrode configured to receive a bias gate signal, a first electrode connected to the initialization voltage, and a second electrode connected to the fourth node, a storage capacitor including a first electrode connected to the third node and a second electrode connected to the first node, and a light emitting element including an anode electrode connected to the fourth node and a cathode electrode connected to a second power supply voltage.

In an embodiment of an electronic device according to the present inventive concept, the electronic device comprises a display panel including a pixel circuit, a display panel driver configured to drive the display panel, and a processor configured to control the display panel driver, wherein the pixel circuit includes a first transistor including a gate electrode connected to a first node, a first electrode connected to a first power supply voltage, and a second electrode connected to a second node, a second transistor including a gate electrode configured to receive a data write gate signal, a first electrode connected to a data line and configured to receive a data voltage transmitted through the data line, and a second electrode connected to a third node, a third transistor including a gate electrode configured to receive a compensation gate signal, a first electrode connected to the first node, and a second electrode connected to the second node, a fourth transistor including a gate electrode configured to receive an initialization gate signal, a first electrode connected to an initialization voltage, and a second electrode connected to the first node, a fifth transistor including a gate electrode configured to receive an emission signal, a first electrode connected to the second node, and a second electrode connected to a fourth node, a sixth transistor including a gate electrode configured to receive a first reset gate signal, a first electrode connected to a first reference voltage, and a second electrode connected to the third node, a seventh transistor including a gate electrode configured to receive a bias gate signal, a first electrode connected to the initialization voltage, and a second electrode connected to the fourth node, an eighth transistor including a gate electrode configured to receive a second reset gate signal, a first electrode connected to a second reference voltage different from the first reference voltage, and a second electrode connected to the third node, a storage capacitor including a first electrode connected to the third node and a second electrode connected to the first node, and a light emitting element including an anode electrode connected to the fourth node and a cathode electrode connected to a second power supply voltage, wherein the processor is configured to control the display panel driver to perform a first compensation operation for compensating threshold voltage variation of the first transistor by initializing the third node to the initialization voltage and thereafter providing the first reference voltage to the third node, and to perform a second compensation operation by providing the data voltage to the third node and thereafter providing the second reference voltage to the third node.

According to the pixel circuit, the display device, and the electronic device, the pixel circuit may sequentially perform a first compensation operation for compensating threshold voltage variation of a driving transistor of the pixel circuit using a first reference voltage VREF1, a data write operation for the pixel circuit, and a second compensation operation for compensating the threshold voltage of the driving transistor using a second reference voltage VREF2 different from the first reference voltage VREF1. As the pixel circuit may perform the first and second compensation operations for compensating the threshold voltage variation of the driving transistor with a single capacitor, a number of masks and corresponding process steps for fabricating the display device may be reduced.

### BRIEF DESCRIPTION OF THE DRAWINGS

The above and other features of embodiments of the present inventive concept will become more apparent by describing in detailed embodiments thereof with reference to the accompanying drawings, in which:

FIG. 1 is a block diagram showing a display device according to embodiments of the present inventive concept;

FIG. 2 is a circuit diagram showing an example of a pixel circuit of a display panel of FIG. 1;

FIG. 3 is a timing diagram showing an example of an operation of a pixel circuit of FIG. 2;

FIG. 4 is a circuit diagram showing an example of an operation of a pixel circuit of FIG. 2 in an initialization period of FIG. 3;

FIG. 5 is a circuit diagram showing an example of an operation of a pixel circuit of FIG. 2 in a first compensation period of FIG. 3;

FIG. 6 is a circuit diagram showing an example of an operation of a pixel circuit of FIG. 2 in a second compensation/data write period of FIG. 3;

FIG. 7 is a circuit diagram showing an example of an operation of a pixel circuit of FIG. 2 in a data transmission period of FIG. 3;

FIG. 8 is a circuit diagram showing an example of an operation of a pixel circuit of FIG. 2 in an emission period of FIG. 3;

FIG. 9 is a circuit diagram showing an example of a pixel circuit of a display panel of FIG. 1;

FIG. 10 is a circuit diagram showing an example of a pixel circuit of a display panel of FIG. 1;

FIG. 11 is a timing diagram showing an example of an operation of a pixel circuit of FIG. 10;

FIG. 12 is a circuit diagram showing an example of an operation of a pixel circuit of FIG. 10 in an initialization period of FIG. 11;

FIG. 13 is a circuit diagram showing an example of an operation of a pixel circuit of FIG. 10 in a first compensation period of FIG. 11;

FIG. 14 is a circuit diagram showing an example of an operation of a pixel circuit of FIG. 10 in a second compensation/data write period of FIG. 11;

FIG. 15 is a circuit diagram showing an example of an operation of a pixel circuit of FIG. 10 in a data transmission period of FIG. 11;

FIG. 16 is a circuit diagram showing an example of an operation of a pixel circuit of FIG. 10 in an emission period of FIG. 11;

FIG. 17 is a block diagram showing an electronic device according to an embodiment of the present inventive concept;

FIG. 18 is a diagram showing an example in which an electronic device of FIG. 17 is implemented as a smart phone;

FIG. 19 is a block diagram showing an electronic device according to an embodiment of the present inventive concept; and

FIG. 20 is schematic diagrams showing the electronic devices of FIG. 19.

### DETAILED DESCRIPTION OF THE EMBODIMENTS

Hereinafter, the present inventive concept will be described in more detail with reference to the accompanying drawings.

The display device includes a pixel circuit that sequentially performs a first compensation operation for compensating threshold voltage variation of a driving transistor of the pixel circuit using a first reference voltage VREF1, a data write operation for the pixel circuit, and a second compensation operation for compensating the threshold voltage of the driving transistor using a second reference voltage VREF2 different from the first reference voltage VREF1. As the pixel circuit may perform the first and second compensation operations for compensating the threshold voltage variation of the driving transistor with a single capacitor, a number of masks and corresponding process steps for fabricating the display device may be reduced.

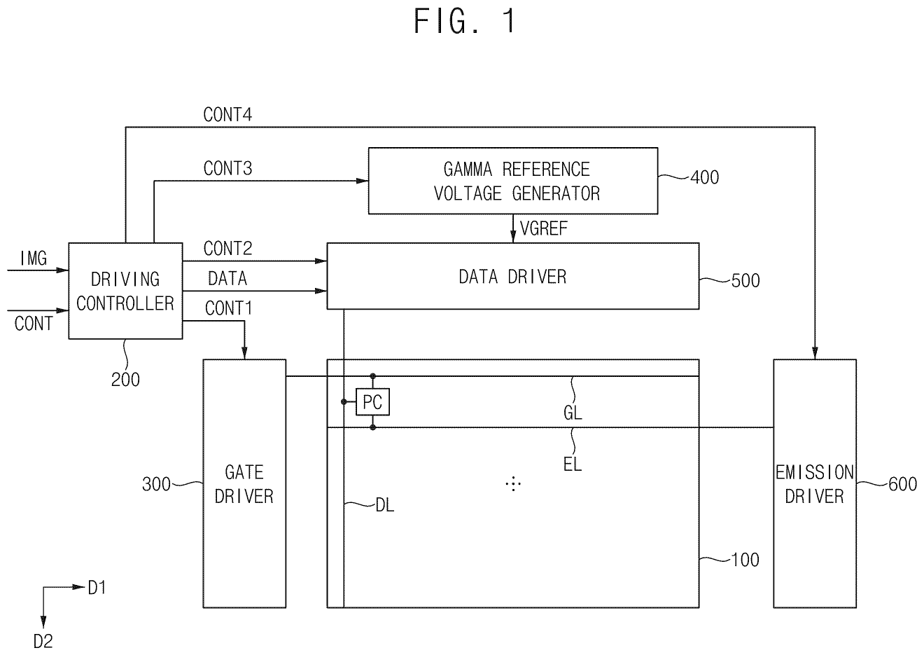

FIG. 1 is a block diagram showing a display device according to embodiments of the present inventive concept.

Referring to FIG. 1, a display device may include a display panel 100 and a display panel driver. The display panel driver may include a driving controller 200, a gate driver 300, a gamma reference voltage generator 400, and a data driver 500. The display panel driver may further include an emission driver 600. Each of the driving controller 200, the gate driver 300, the gamma reference voltage generator 400, and the data driver 500 may be implemented as a separate unit. The “unit” may be a chip or a driving module.

Alternatively, some of the driving controller 200, the gate driver 300, the gamma reference voltage generator 400, and the data driver 500 may be integrated into a single unit. For example, the driving controller 200 and the data driver 500 may be integrated into a single unit. For example, the driving controller 200, the gamma reference voltage generator 400, and the data driver 500 may be integrated into a single unit. For example, the driving controller 200, the gate driver 300, the gamma reference voltage generator 400, and the data driver 500 may be integrated into a single chip. For example, the driving controller 200, the gate driver 300, the gamma reference voltage generator 400, the data driver 500, and the emission driver 600 may be integrated into a single circuit block. When the driving controller 200 and the data driver 500 are integrated into a single driving module, the driving module may be referred to as a timing controller embedded data driver (TED).

The display panel 100 may include a display area for displaying an image and a peripheral area disposed adjacent to the display area. Depending on applications of the display panel 100, different type of the display panel 100 may be used.

For example, in an embodiment, the display panel 100 may be an organic light emitting diode display panel including an organic light emitting diode. For example, the display panel 100 may be a quantum-dot organic light emitting diode display panel including an organic light emitting diode and a quantum-dot color filter. For example, the display panel 100 may be a quantum-dot nano light emitting diode display panel including a nano light emitting diode and a quantum-dot color filter.

The display panel 100 may include gate lines GL, data lines DL, emission lines EML, and pixel circuits PC electrically connected to the gate lines GL, the data lines DL, and the emission lines EL, respectively. The gate lines GL may extend in a first direction D1, the data lines DL may extend in a second direction D2 crossing the first direction D1, and the emission lines EL may extend in the first direction D1.

The driving controller 200 may receive input image data IMG and an input control signal CONT from an external device (not shown). For example, the input image data IMG may include red image data, green image data and blue image data. The input image data IMG may further include white image data. In some embodiments, the input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 200 may generate a first control signal CONT1, a second control signal CONT2, a third control signal CONT3, a fourth control signal CONT4, and a data signal DATA based on the input image data IMG and the input control signal CONT.

The driving controller 200 may provide the gate driver 300 with the first control signal CONT1 for controlling an operation of the gate driver 300 based on the input control signal CONT. The first control signal CONT1 may include a vertical start signal and a gate clock signal.

The driving controller 200 may provide the data driver 500 with the second control signal CONT2 for controlling an operation of the data driver 500 based on the input control signal CONT. The second control signal CONT2 may include a horizontal start signal and a load signal.

The driving controller 200 may provide the data driver 500 with the data signal DATA generated based on the input image data IMG. The data driver 500 may drive the data signal DATA to the display panel 100.

The driving controller 200 may provide the gamma reference voltage generator 400 with the third control signal CONT3 for controlling an operation of the gamma reference voltage generator 400 based on the input control signal CONT.

The driving controller 200 may provide the emission driver 600 with the fourth control signal CONT4 for controlling an operation of the emission driver 600 based on the input control signal CONT.

The gate driver 300 may generate gate signals in response to the first control signal CONT1 received from the driving controller 200, and may provide the gate signals to the gate lines GL for driving the gate lines GL.

In an embodiment, the gate driver 300 may be integrated into the peripheral area of the display panel 100. In another embodiment, the gate driver 300 may be mounted on the peripheral area of the display panel 100 as a separate unit.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may be a reference value with which the data driver performs a gamma correction to produce precise voltage outputs for each pixel based on each data signal DATA.

The gamma reference voltage generator 400 may be disposed within the driving controller 200. Alternatively, the gamma reference voltage generator 400 may be disposed within the data driver 500.

The data driver 500 may receive the second control signal CONT2 and the data signal DATA from the driving controller 200, and receive the gamma reference voltage VGREF from the gamma reference voltage generator 400. The data driver 500 may convert the data signal DATA into a data voltage having an analog type using the gamma reference voltage VGREF. The data driver 500 may output the data voltage to the data line DL.

In an embodiment, the data driver 500 may be integrated into the peripheral area of the display panel 100. In another embodiment, the data driver 500 may be mounted on the peripheral area of the display panel 100 as a separate unit.

The emission driver 600 may generate emission signals for driving the emission lines EML in response to the fourth control signal CONT4 received from the driving controller 200. The emission driver 600 may provide the emission signals to the emission lines EML.

In an embodiment, the emission driver 600 may be integrated into the peripheral area of the display panel 100. In another embodiment, the emission driver 600 may be mounted on the peripheral area of the display panel 100 as a separate unit.

In FIG. 1, for a convenience of an explanation, the gate driver 300 may be disposed on a first side of the display panel 100 and the emission driver 600 may be disposed on a second side of the display panel 100. However, the present inventive concept is not limited thereto. For example, both the gate driver 300 and the emission driver 600 may be disposed on the first side of the display panel 100. For example, both the gate driver 300 and the emission driver 600 may be disposed on both sides of the display panel 100. For example, the gate driver 300 and the emission driver 600 may be integrally formed as a single unit.

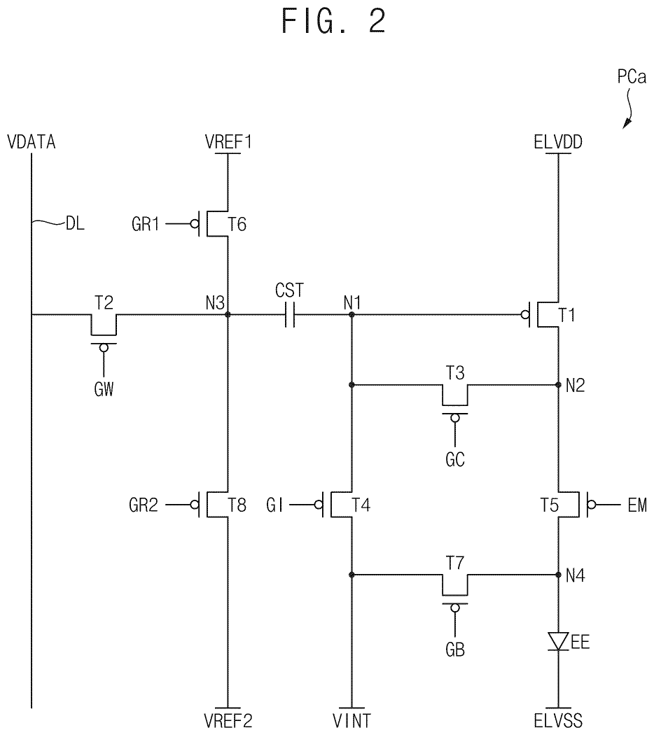

FIG. 2 is a circuit diagram showing an example pixel circuit PCa of a pixel circuit PC of a display panel 100 of FIG. 1.

Referring to FIGS. 1 and 2, the pixel circuit PCa may include a first transistor T1, a second transistor T2, a third transistor T3, a fourth transistor T4, a fifth transistor T5, a sixth transistor T6, and a seventh transistor T7. In an embodiment, the pixel circuit PCa may further include an eighth transistor T8.

In an embodiment, the first transistor T1, the second transistor T2, the third transistor T3, the fourth transistor T4, the fifth transistor T5, the sixth transistor T6, the seventh transistor T7, and the eighth transistor T8 may be positive-type metal-oxide-semiconductor (PMOS) transistors.

The PMOS transistor may be turned on when the absolute value of a gate-source voltage of the PMOS transistor is greater than or equal to the absolute value of a threshold voltage of the PMOS transistor which is typically negative value. On the other hand, the PMOS transistor may be turned off when the absolute value of the gate-source voltage of the PMOS transistor is smaller than the absolute value of the threshold voltage of the PMOS transistor. For example, when a gate signal at a logic low level is applied to a gate electrode of the PMOS transistor, and a source voltage at a logic high level is applied to source electrode of the PMOS transistor, the PMOS transistor may be turned on. Conversely, when a gate signal at a logic high level is applied to the gate electrode of the PMOS transistor, the PMOS transistor may be turned off. The logic low level applied to the gate electrode of the PMOS transistor may correspond to a voltage level that turns on the PMOS transistor, whereas the logic high level applied to the gate electrode of the PMOS transistor may correspond to a voltage level that turns off the PMOS transistor.

The first transistor T1 may include a gate electrode connected to a first node N1, a first electrode receiving a first power supply voltage ELVDD, and a second electrode connected to a second node N2. The first transistor T1 may be turned on depending on the voltage of the first node N1 and the first power supply voltage ELVDD, thereby generating a driving current. Specifically, the first transistor T1 may generate the driving current based on the difference between the voltage of the first node N1 and the first power supply voltage ELVDD. More specifically, as the difference between the voltage of the first node N1 and the first power supply voltage ELVDD increases, a magnitude of the driving current may also increase. The first transistor T1 may be referred to as a driving transistor.

The second transistor T2 may include a gate electrode receiving a data write gate signal GW, a first electrode connected to a data line DL that transmits a data voltage VDATA, and a second electrode connected to a third node N3. The second transistor T2 may be turned on in response to a data write gate signal GW at a logic low level, thereby providing the data voltage VDATA to the third node N3. The second transistor T2 may be referred to as a data write transistor.

The third transistor T3 may include a gate electrode receiving a compensation gate signal GC, a first electrode connected to the first node N1, and a second electrode connected to the second node N2. The third transistor T3 may be turned on in response to a compensation gate signal GC at a logic low level, thereby connecting the first node N1 and the second node N2. Specifically, the third transistor T3 may be turned on in response to the compensation gate signal GC at the logic low level to diode-connect the first transistor T1. More specifically, the third transistor T3 may be turned on in response to the compensation gate signal GC at the logic low level, thereby connecting the gate electrode (e.g., the first node N1) of the first transistor T1 and the drain electrode (e.g., the second node N2) of the first transistor T1 in a diode configuration. The third transistor T3 may be referred to as a compensation transistor.

The fourth transistor T4 may include a gate electrode receiving an initialization gate signal GI, a first electrode receiving an initialization voltage VINT, and a second electrode connected to the first node N1. The fourth transistor T4 may be turned on in response to an initialization gate signal GI at a logic low level, thereby providing the initialization voltage VINT to the first node N1. The fourth transistor T4 may be referred to as an initialization transistor.

The fifth transistor T5 may include a gate electrode receiving an emission signal EM, a first electrode connected to the second node N2, and a second electrode connected to the fourth node N4. The fifth transistor T5 may be turned on in response to an emission signal EM at a logic low level, thereby connecting the second node N2 and the fourth node N4. When the fifth transistor T5 is turned on, the fifth transistor T5 may provide the driving current to the light emitting element EE. The fifth transistor T5 may be referred to as an emission control transistor.

The sixth transistor T6 may include a gate electrode receiving a first reset gate signal GR1, a first electrode receiving a first reference voltage VREF1, and a second electrode connected to the third node N3. The sixth transistor T6 may be turned on in response to a first reset gate signal GR1 at a logic low level, thereby providing the first reference voltage VREF1 to the third node N3. The sixth transistor T6 may be referred to as a first reset transistor.

The seventh transistor T7 may include a gate electrode receiving a bias gate signal GB, a first electrode receiving the initialization voltage VINT, and a second electrode connected to the fourth node N4. The seventh transistor T7 may be turned on in response to a bias gate signal GB at a logic low level, thereby providing the initialization voltage VINT to the fourth node N4. The seventh transistor T7 may be referred to as an anode initialization transistor.

The eighth transistor T8 may include a gate electrode receiving a second reset gate signal GR2, a first electrode receiving a second reference voltage VREF2 different from the first reference voltage VREF1, and a second electrode connected to the third node N3. The eighth transistor T8 may be turned on in response to a second reset gate signal GR2 at a logic low level, thereby providing the second reference voltage VREF2 to the third node N3. The eighth transistor T8 may be referred to as a second reset transistor.

The storage capacitor CST may include a first electrode connected to the third node N3 and a second electrode connected to the first node N1. The storage capacitor CST may store the data voltage VDATA at its first electrode (e.g., the third node N3), and may boost the voltage of its second electrode (e.g., the first node N1) in response to transitioning of the voltage at the third node N3.

The light emitting element EE may include an anode electrode connected to the fourth node N4 and a cathode electrode receiving a second power supply voltage ELVSS. The light emitting element EE may emit a light based on the driving current. As the magnitude of the driving current increases, a luminance (i.e., an emission intensity) of the light emitting element EE may also increase.

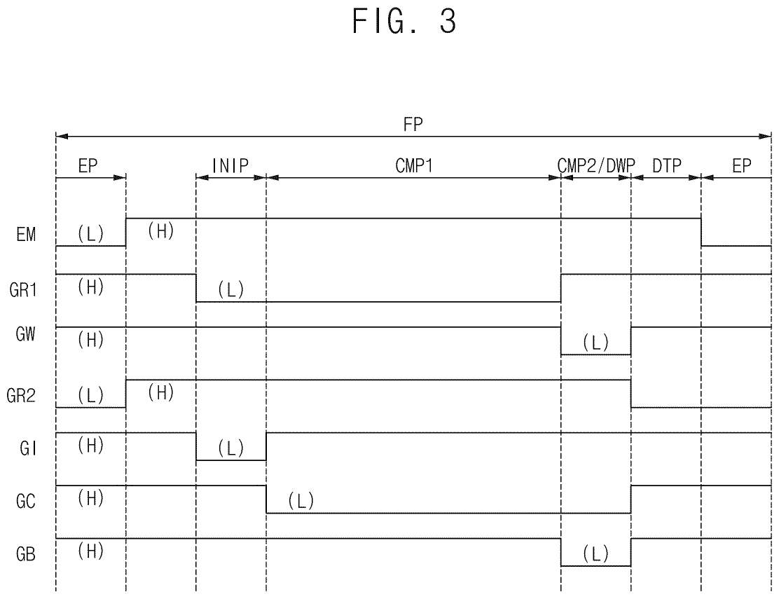

FIG. 3 is a timing diagram showing an example of an operation of a pixel circuit PCa of FIG. 2.

Referring to FIGS. 1 to 3, the pixel circuit PCa may operate on a frame-by-frame basis. A frame period FP of the pixel circuit PCa may include an initialization period INIP, a first compensation period CMP1, a second compensation/data write period CMP2/DWP, a data transmission period DTP, and an emission period EP.

Hereinafter, “the high level H” may refer to a logic high level, and “the low level L” may refer to a logic low level. During the initialization period INIP, the emission signal EM may be at the high level H, the first reset gate signal GR1 may be at the low level L, the data writing gate signal GW may be at the high level H, the second reset gate signal GR2 may be at the high level H, the initialization gate signal GI may be at the low level L, the compensation gate signal GC may be at the high level H, and the bias gate signal GB may be at the high level H.

During the first compensation period CMP1, the emission signal EM may be at the high level H, the first reset gate signal GR1 may be at the low level L, the data write gate signal GW may be at the high level H, the second reset gate signal GR2 may be at the high level H, the initialization gate signal GI may be at the high level H, the compensation gate signal GC may be at the low level L, and the bias gate signal GB may be at the high level H. During the second compensation/data write period CMP2/DWP, the emission signal EM may be at the high level H, the first reset gate signal GR1 may be at the high level H, the data write gate signal GW may be at the low level L, the second reset gate signal GR2 may be at the high level H, the initialization gate signal GI may be at the high level H, the compensation gate signal GC may be at the low level L, and the bias gate signal GB may be at the low level L.

During the data transmission period DTP, the emission signal EM may be at the high level H, the first reset gate signal GR1 may be at the high level H, the data write gate signal GW may be at the high level H, the second reset gate signal GR2 may be at the low level L, the initialization gate signal GI may be at the high level H, the compensation gate signal GC may be at the high level H, and the bias gate signal GB may be at the high level H.

During the emission period EP, the emission signal EM may be at the low level L, the first reset gate signal GR1 may be at the high level H, the data write gate signal GW may be at the high level H, the second reset gate signal GR2 may be at the low level L, the initialization gate signal GI may be at the high level H, the compensation gate signal GC may be at the high level H, and the bias gate signal GB may be at the high level H.

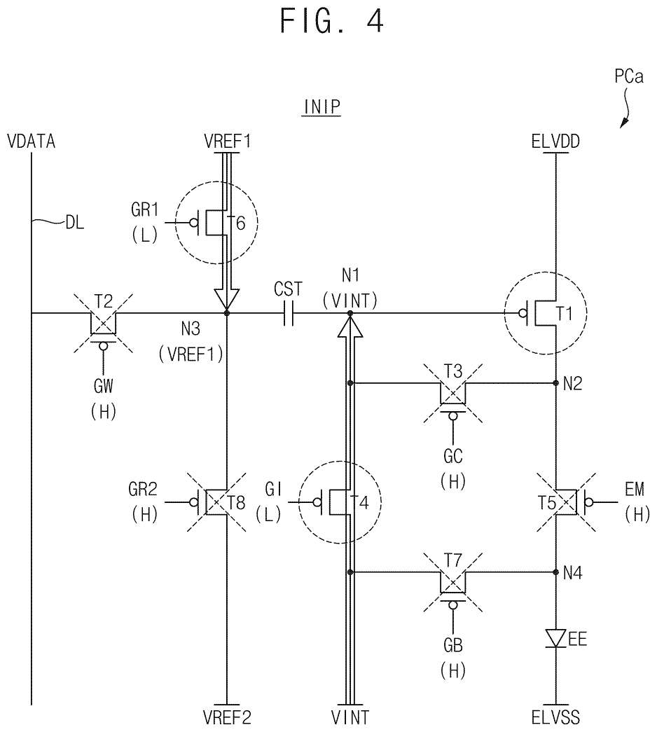

FIG. 4 is a circuit diagram showing an example of an operation of a pixel circuit PCa of FIG. 2 in an initialization period INIP of FIG. 3.

Referring to FIGS. 1 to 4, in the initialization period INIP, an initialization operation for the gate electrode of the first transistor T1 and an initialization operation for the storage capacitor CST may be performed.

During the initialization period INIP, the second transistor T2 may be turned off in response to the data write gate signal GW with the high level H, the third transistor T3 may be turned off in response to the compensation gate signal GC with the high level H, the fourth transistor T4 may be turned on in response to the initialization gate signal GI with the low level L, the fifth transistor T5 may be turned off in response to the emission signal EM with the high level H, the sixth transistor T6 may be turned on in response to the first reset gate signal GR1 with the low level L, the seventh transistor T7 may be turned off in response to the bias gate signal GB with the high level H, and the eighth transistor T8 may be turned off in response to the second reset gate signal GR2 with the high level H.

As the fourth transistor T4 is turned on, the initialization voltage VINT may be supplied to the first node N1, thereby initializing the voltage of the first node N1 to the initialization voltage VINT. Accordingly, the voltage of the gate electrode of the first transistor T1 may be initialized to the initialization voltage VINT, and the voltage of the second electrode of the storage capacitor CST may be initialized to the initialization voltage VINT.

As the voltage of the gate electrode of the first transistor T1 (i.e., the first node N1) is initialized to the initialization voltage VINT (e.g., a logic low voltage) and the voltage of the source electrode (i.e., the first electrode) of the first transistor T1 is supplied with the first power supply voltage ELVDD, an absolute value of the gate-source voltage (i.e., “|VINT−ELVDD|”) of the first transistor T1 may be greater than or equal to an absolute value of the threshold voltage of the first transistor T1 (i.e., |VTH| of the first transistor T1). Accordingly, the first transistor T1 may be turned on.

As the sixth transistor T6 is turned on to provide the first reference voltage VREF1 to the third node N3, the voltage of the third node N3 may be set to the first reference voltage VREF1. Accordingly, the voltage of the first electrode of the storage capacitor CST may be set to the first reference voltage VREF1.

As a result of the initialization operation for the gate electrode of the first transistor T1 and the initialization operation for the storage capacitor CST during the initialization period INIP, the first node N1 may be initialized to the initialization voltage VINT and the third node N3 may be set to the first reference voltage VREF1.

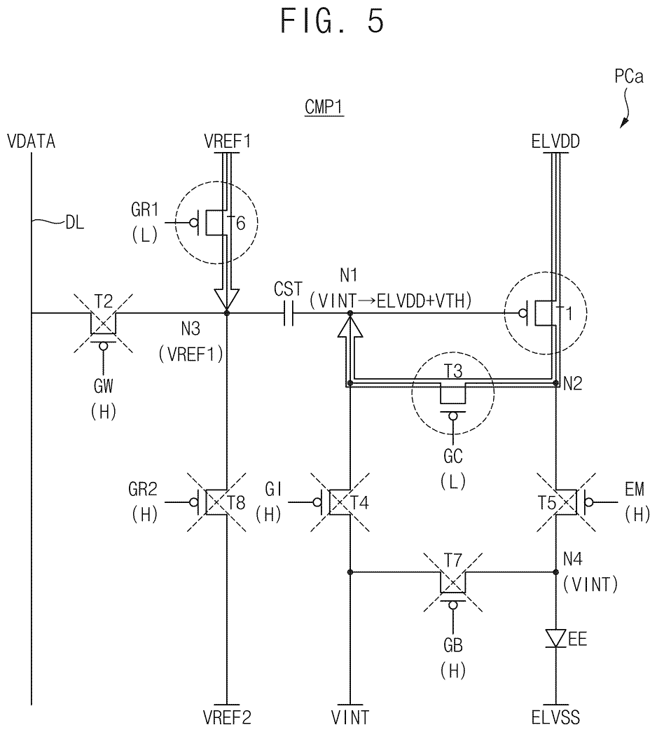

FIG. 5 is a circuit diagram showing an example of an operation of a pixel circuit PCa of FIG. 2 in a first compensation period CMP1 of FIG. 3.

Referring to FIGS. 1 to 5, in the first compensation period CMP1, a first compensation operation for the threshold voltage VTH of the first transistor T1 may be performed.

During the first compensation period CMP1, the second transistor T2 may be turned off in response to the data write gate signal GW with the high level H, the third transistor T3 may be turned on in response to the compensation gate signal GC with the low level L, the fourth transistor T4 may be turned off in response to the initialization gate signal GI with the high level H, the fifth transistor T5 may be turned off in response to the emission signal EM with the high level H, the sixth transistor T6 may be turned on in response to the first reset gate signal GR1 with the low level L, the seventh transistor T7 may be turned off in response to the bias gate signal GB with the high level H, and the eighth transistor T8 may be turned off in response to the second reset gate signal GR2 with the high level H.

As the voltage of the gate electrode (i.e., the first node N1) of the first transistor T1 is set to the initialization voltage VINT (e.g., a logic low voltage), and the voltage of the source electrode (i.e., the first electrode) of the first transistor T1 is the first power supply voltage ELVDD, an absolute value of the gate-source voltage (i.e., “|VINT−ELVDD|”) of the first transistor T1 may be greater than or equal to an absolute value of the threshold voltage VTH of the first transistor T1 (i.e., “|VTH| of the first transistor T1”). Therefore, the first transistor T1 may be turned on.

The third transistor T3 may be turned on to connect the first node N1 and the third node N3. Specifically, the third transistor T3 may be turned on to diode-connect the first transistor T1. More specifically, the third transistor T3 may be turned on in response to the compensation gate signal GC with the logic low level to connect the gate electrode (e.g., the first node N1) and the drain electrode (e.g., the second node N2) of the first transistor T1 in a diode configuration.

When both the first transistor T1 and the third transistor T3 are turned on, a current path is established through the first transistor T1 and the third transistor T3. As a result, the voltage of the first node N1 may transition from the initialization voltage VINT to a first voltage level determined by the current flow through the current path. The first voltage level may correspond to the first power supply voltage ELVDD minus the absolute value of the threshold voltage VTH of the first transistor T1 (i.e., “ELVDD−|VTH|”).

As a result of the turning on both the first transistor T1 and the third transistor T3 in the first compensation period CMP1, the first transistor T1 is connected in a diode configuration, and the storage capacitor CST may store the first voltage level (i.e., “ELVDD−|VTH|”) at its second electrode, thereby compensating for the variation in the threshold voltage VTH of the first transistor T1. Accordingly, the first compensation operation for compensating the variation in the threshold voltage VTH of the first transistor T1 may be performed.

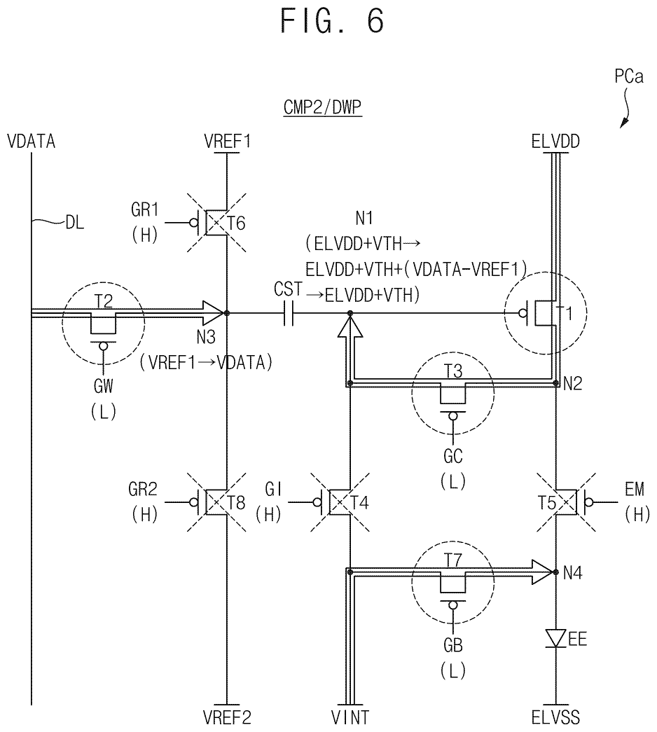

FIG. 6 is a circuit diagram showing an example of an operation of a pixel circuit PCa of FIG. 2 in a second compensation/data write period CMP2/DWP of FIG. 3.

Referring to FIGS. 1 to 6, in the second compensation/data write period CMP2/DWP, a second compensation operation for the threshold voltage VTH of the first transistor T1 may be performed, a data write operation for the pixel circuit PCa may be performed, and an anode initialization operation for the light emitting element EE may be performed.

In the second compensation/data write period CMP2/DWP, the second transistor T2 may be turned on in response to the data write gate signal GW with the low level L, the third transistor T3 may be turned on in response to the compensation gate signal GC with the low level L, the fourth transistor T4 may be turned off in response to the initialization gate signal GI with the high level H, the fifth transistor T5 may be turned off in response to the emission signal EM with the high level H, the sixth transistor T6 may be turned off in response to the first reset gate signal GR1 with the high level H, the seventh transistor T7 may be turned on in response to the bias gate signal GB with the low level L, and the eighth transistor T8 may be turned off in response to the second reset gate signal GR2 with the high level H.

As the second transistor T2 turns on, the data voltage VDATA transmitted through the data line DL may be applied to the third node N3, causing the voltage of the third node N3 to transition from the first reference voltage VREF1 to the data voltage VDATA, resulting in a voltage change at the third node N3 equal to the difference between the data voltage VDATA and the first reference voltage VREF1 (i.e., “VDATA−VREF1”).

In response to the voltage change at the third node N3, the storage capacitor CST may boost the voltage of the first node N1 in proportion to the voltage change at the third node N3 (i.e., “VDATA−VREF1”). Therefore, in response to the voltage change at the third node N3 by an amount equal to the difference between the data voltage VDATA and the first reference voltage VREF1 (i.e., “VDATA−VREF1”), the storage capacitor CST may boost the voltage of the first node N1 by the same amount. Accordingly, the voltage of the first node N1 may be boosted by the amount equal to the difference between the data voltage VDATA and the first reference voltage VREF1 (i.e., “VDATA−VREF1”), causing voltage level of the first node N1 to transition from the first power supply voltage ELVDD minus the absolute value of the threshold voltage VTH of the first transistor T1 (i.e., “ELVDD−|VTH|”) to “ELVDD−|VTH|+(VDATA−VREF1)”.

As a result, the gate-source voltage of the first transistor T1 may be changed to “ELVDD−|VTH|+(VDATA−VREF1)−ELVDD” (i.e., “VTH+VDATA−VREF1”). The compensation operation for the threshold voltage VTH of the first transistor T1 may be performed when the first transistor T1 is turned on. The first transistor T1 may be turned on when the gate-source voltage (i.e., “VTH+VDATA−VREF1”) of the first transistor T1 is lower than or equal to the threshold voltage VTH of the first transistor T1 (i.e., VTH+VDATA−VREF1≤VTH). Therefore, the first transistor T1 may be turned on when the first reference voltage VREF1 is greater than or equal to the data voltage VDATA (i.e., VDATA≤VREF1). Because the data voltage VDATA may vary according to a grayscale of the input image data IMG, the first reference voltage VREF1 may be set to have a value greater than or equal to a maximum value of the data voltage VDATA. The maximum value of the data voltage VDATA may correspond to a maximum grayscale of the input image data IMG.

The third transistor T3 may be turned on to connect the first node N1 and the third node N3. When the third transistor T3 is turned on, the first transistor T1 may be connected in a diode configuration.

When both the first transistor T1 and the third transistor T3 are turned on, the voltage of the first node N1 may transition from “ELVDD−|VTH|+(VDATA−VREF1)” to the first power supply voltage ELVDD minus the absolute value of the threshold voltage VTH of the first transistor T1 (i.e., “ELVDD−|VTH|”).

When the seventh transistor T7 is turned on, the initialization voltage VINT may be supplied to the fourth node N4. Therefore, a voltage of the fourth node N4 may be initialized to the initialization voltage VINT. Accordingly, the anode electrode of the light emitting element EE may be initialized to the initialization voltage VINT.

As a result, in the second compensation/data write period CMP2/DWP, when the first transistor T1 is turned on and the third transistor T3 is turned on to diode-connect the first transistor T1, the storage capacitor CST may store a voltage level at its second electrode that reflects variation in the threshold voltage VTH of the first transistor T1 (i.e., “ELVDD−|VTH|”), thereby enabling tracking of the threshold voltage variation of the first transistor T1. Therefore, the second compensation operation for the threshold voltage VTH of the first transistor T1 may be performed. In addition, when the second transistor T2 is turned on, and the data voltage VDATA transmitted through the data line DL is provided to the third node N3, the storage capacitor CST may store the data voltage VDATA at its first electrode. Therefore, the data write operation for the pixel circuit PCa may be performed. In addition, the anode initialization operation for the light emitting element EE may be performed.

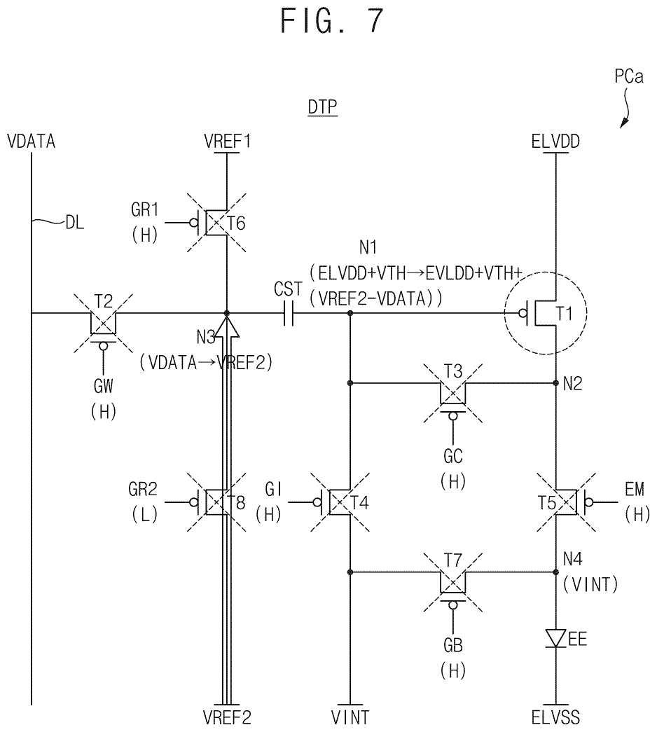

FIG. 7 is a circuit diagram showing an example of an operation of a pixel circuit PCa of FIG. 2 in a data transmission period DTP of FIG. 3.

Referring to FIGS. 1 to 7, a data transmission operation may be performed in a data transmission period DTP.

In the data transmission period DTP, the second transistor T2 may be turned off in response to the data write gate signal GW with the high level H, the third transistor T3 may be turned off in response to the compensation gate signal GC with the high level H, the fourth transistor T4 may be turned off in response to the initialization gate signal GI with the high level H, the fifth transistor T5 may be turned off in response to the emission signal EM with the high level H, the sixth transistor T6 may be turned off in response to the first reset gate signal GR1 with the high level H, the seventh transistor T7 may be turned off in response to the bias gate signal GB with the high level H, and the eighth transistor T8 may be turned on in response to the second reset gate signal GR2 with the low level L.

As the eighth transistor T8 may be turned on, the second reference voltage VREF2 may be provided to the third node N3. Therefore, the voltage of the third node N3 may transition from the data voltage VDATA to the second reference voltage VREF2, causing a voltage change at the third node N3 by an amount equal to the difference between the second reference voltage VREF2 and the data voltage VDATA (i.e., “VREF2−VDATA”).

In response to the voltage change at the third node N3, the storage capacitor CST may boost the voltage of the first node N1 in proportion to the voltage change at the third node N3. Therefore, in response to the voltage change at the third node N3 by an amount equal to the difference between the second reference voltage VREF2 and the data voltage VDATA (i.e., “VREF2−VDATA”), the storage capacitor CST may boost the voltage of the first node N1 by the same amount. Accordingly, the voltage of the first node N1 may be boosted by an amount equal to the difference between the second reference voltage VREF2 and the data voltage VDATA (i.e., “VREF2−VDATA”), causing voltage level of the first node N1 to transition from the first power supply voltage ELVDD minus the threshold voltage VTH of the first transistor T1 (i.e., “ELVDD−|VTH|”) to “ELVDD−|VTH|+(VREF2−VDATA)”.

As a result, the gate-source voltage of the first transistor T1 may be changed to “ELVDD+VTH+(VREF2−VDATA)−ELVDD” (i.e., “VTH+VREF2−VDATA”). The first transistor T1 may generate the driving current in the emission period EP when the first transistor T1 is turned on. The first transistor T1 may be turned on when the gate-source voltage (i.e., “VTH+VREF2−VDATA”) of the first transistor T1 is lower than or equal to the threshold voltage VTH of the first transistor T1 (i.e., VTH+VREF2−VDATA 23 VTH). Therefore, the first transistor T1 may be turned on when the second reference voltage VREF2 is lower than or equal to the data voltage VDATA (i.e., VREF2≤VDATA). Because the data voltage VDATA may vary according to the grayscale of the input image data IMG, the second reference voltage VREF2 may be set to have a value lower than or equal to the maximum value of the data voltage VDATA. For example, the maximum value of the data voltage VDATA may correspond to the maximum grayscale of the input image data IMG.

In the data transmission period DTP, when the eighth transistor T8 is turned on to provide the second reference voltage VREF2 to the third node N3, and the voltage of the third node N3 may be changed from the data voltage VDATA to the second reference voltage VREF2 by an amount equal to the difference between the second reference voltage VREF2 and the data voltage VDATA (i.e., “VREF2−VDATA”), and the storage capacitor CST may correspondingly boost the voltage of the first node N1 by the same amount. Accordingly, the data voltage VDATA may be transmitted from the third node N3 to the first node N1, and the data transmission operation may be performed.

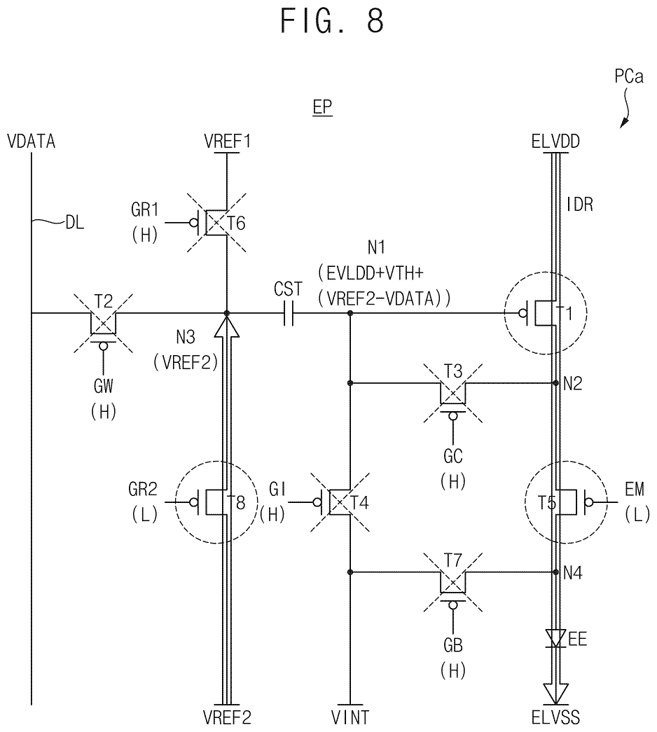

FIG. 8 is a circuit diagram showing an example of an operation of a pixel circuit PCa of FIG. 2 in an emission period EP of FIG. 3.

Referring to FIGS. 1 to 8, in the emission period EP, an emission operation for the light emitting element EE may be performed.

In the emission period EP, the second transistor T2 may be turned off in response to the data write gate signal GW with the high level H, the third transistor T3 may be turned off in response to the compensation gate signal GC with the high level H, the fourth transistor T4 may be turned off in response to the initialization gate signal GI with the high level H, the fifth transistor T5 may be turned on in response to the emission signal EM with the low level L, the sixth transistor T6 may be turned off in response to the first reset gate signal GR1 with the high level H, the seventh transistor T7 may be turned off in response to the bias gate signal GB with the high level H, and the eighth transistor T8 may be turned on in response to the second reset gate signal GR2 with the low level L.

As the eighth transistor T8 is turned on, the second reference voltage VREF2 is provided to the third node N3. Therefore, the voltage at the third node N3 may remain at the second reference voltage VREF2.

The first transistor T1 may be turned on based on the voltage of the first node N1 and the first power supply voltage ELVDD to generate the driving current IDR. Specifically, the first transistor T1 may generate the driving current IDR based on the difference between the voltage of the first node N1 (i.e., “ELVDD+VTH+VREF2−VDATA”) and the first power supply voltage ELVDD (i.e., “VTH+VREF2−VDATA”). Depending on the data voltage VDATA, the difference between the voltage of the first node N1 and the first power supply voltage ELVDD may be changed, thereby varying the magnitude of the driving current IDR according to the data voltage VDATA.

Since the fifth transistor T5 as well as the first transistor T1 are turned on, a current path for the driving current IDR may be established between the first power supply voltage ELVDD and the second power supply voltage ELVSS across the light emitting element EE.

Accordingly, the driving current IDR may flow through the light emitting element EE along the current path established for the driving current IDR. The light emitting element EE may emit the light in a luminance proportional to the driving current IDR. As the magnitude of the driving current IDR increases, the luminance corresponding to the emission intensity of the light emitting element EE may also increase.

As a result, in the light emission period EP, the emission operation for the light emitting element EE may be performed.

As illustrated with reference to FIGS. 3 to 8, the pixel circuit PCa may sequentially perform the first compensation operation for the threshold voltage VTH of the first transistor T1, the data write operation for the pixel circuit PCa, and the second compensation operation for the threshold voltage VTH of the first transistor T1 using the first reference voltage VREF1 and the second reference voltage VREF2 different from the first reference voltage VREF1. Accordingly, the pixel circuit PCa may perform the first and second compensation operations for the threshold voltage VTH of the first transistor T1 with a single capacitor CST.

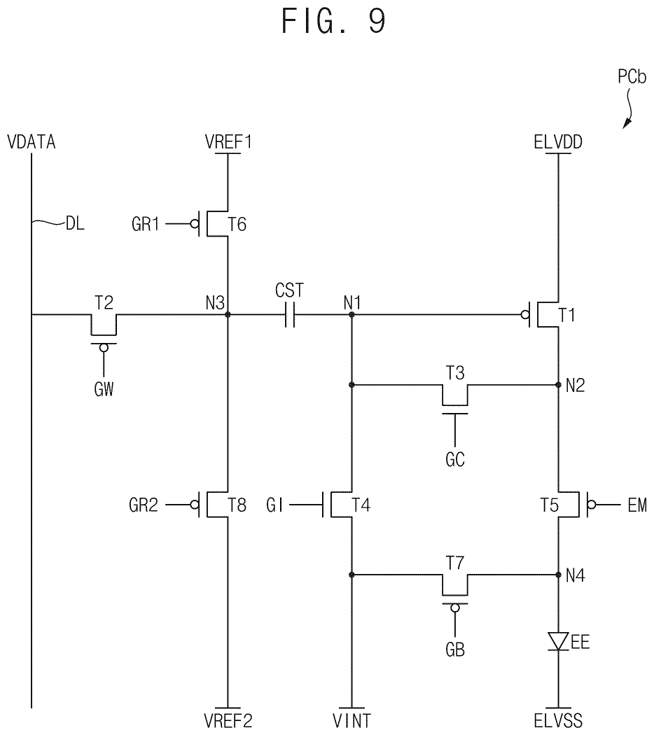

FIG. 9 is a circuit diagram showing an example PCb of a pixel circuit PC of a display panel 100 of FIG. 1.

Referring to FIGS. 1 to 9, a pixel circuit PCb of FIG. 9 is substantially equal to a pixel circuit PCa of FIG. 2 except for changes in a third transistor T3 and a fourth transistor T4. Specifically, a third transistor T3 and a fourth transistor T4 included in the pixel circuit PCa of FIG. 2 are PMOS transistors, whereas a third transistor T3 and a fourth transistor T4 included in the pixel circuit PCb of FIG. 9 are negative-type metal-oxide-semiconductor (NMOS) transistors. Therefore, an operation of the pixel circuit PCb of FIG. 9 is similar to an operation of the pixel circuit PCa of FIG. 2. Accordingly, a description of the operation of the pixel circuit PCb of FIG. 9 is omitted.

The pixel circuit PCb may include a first transistor T1, a second transistor T2, a third transistor T3, a fourth transistor T4, a fifth transistor T5, a sixth transistor T6, and a seventh transistor T7. In an embodiment, the pixel circuit PCb may further include an eighth transistor T8.

In an embodiment, the first transistor T1, the second transistor T2, the fifth transistor T5, the sixth transistor T6, the seventh transistor T7, and the eighth transistor T8 may be PMOS transistors, and the third transistor T3 and the fourth transistor T4 may be NMOS transistors.

The PMOS transistor may be turned on when an absolute value of a gate-source voltage of the PMOS transistor is greater than or equal to an absolute value of a threshold voltage of the PMOS transistor which is typically negative value. On the other hand, the PMOS transistor may be turned off when the absolute value of the gate-source voltage of the PMOS transistor is smaller than the absolute value of the threshold voltage of the PMOS transistor. For example, when a gate signal with a logic low level is applied to a gate electrode of the PMOS transistor, the PMOS transistor may be turned on. For example, when a gate signal with a logic high level is applied to the gate electrode of the PMOS transistor, the PMOS transistor may be turned off.

The NMOS transistor may be turned on when a gate-source voltage of the NMOS transistor is greater than or equal to the threshold voltage of the NMOS transistor which is typically positive value. On the other hand, the NMOS transistor may be turned off when the gate-source voltage of the NMOS transistor is lower than the threshold voltage of the NMOS transistor. For example, when a gate signal with a logic high level is applied to the gate electrode of the NMOS transistor, the NMOS transistor may be turned on. On the other hand, when a gate signal with a logic low level is applied to the gate electrode of the NMOS transistor, the NMOS transistor may be turned off.

The first transistor T1 may include a gate electrode connected to a first node N1, a first electrode receiving a first power supply voltage ELVDD, and a second electrode connected to a second node N2. The first transistor T1 may be turned on based on a voltage of the first node N1 and the first power supply voltage ELVDD to generate a driving current. Specifically, the first transistor T1 may generate the driving current based on a difference between the voltage of the first node N1 and the first power supply voltage ELVDD. More specifically, as the difference between the voltage of the first node N1 and the first power supply voltage ELVDD increases, a magnitude of the driving current may also increase. The first transistor T1 may be referred to as a driving transistor.

The second transistor T2 may include a gate electrode receiving a data write gate signal GW, a first electrode connected to a data line DL through which a data voltage VDATA is transmitted, and a second electrode connected to a third node N3. The second transistor T2 may be turned on in response to a data write gate signal GW with a logic low level to provide the data voltage VDATA to the third node N3. The second transistor T2 may be referred to as a data write transistor.

The third transistor T3 may include a gate electrode receiving a compensation gate signal GC, a first electrode connected to the first node N1, and a second electrode connected to the second node N2. The third transistor T3 may be turned on in response to a compensation gate signal GC with the logic high level to connect the first node N1 and the second node N2. Specifically, the third transistor T3 may be turned on in response to the compensation gate signal GC with a logic high level to diode-connect the first transistor T1. More specifically, the third transistor T3 may be turned on in response to the compensation gate signal GC with a logic high level to connect the gate electrode (e.g., the first node N1) and the drain electrode (e.g., the second node N2) of the first transistor T1 in a diode configuration. The third transistor T3 may be referred to as a compensation transistor.

The fourth transistor T4 may include a gate electrode receiving an initialization gate signal GI, a first electrode receiving an initialization voltage VINT, and a second electrode connected to the first node N1. The fourth transistor T4 may be turned on in response to an initialization gate signal GI with a logic high level to provide the initialization voltage VINT to the first node N1. The fourth transistor T4 may be referred to as an initialization transistor.

The fifth transistor T5 may include a gate electrode receiving an emission signal EM, a first electrode connected to the second node N2, and a second electrode connected to a fourth node N4. The fifth transistor T5 may be turned on in response to an emission signal EM with a logic low level to connect the second node N2 and the fourth node N4. When the fifth transistor T5 is turned on, the fifth transistor T5 may provide the driving current to the light emitting element EE. The fifth transistor T5 may be referred to as an emission control transistor. The sixth transistor T6 may include a gate electrode receiving a first reset gate signal GR1, a first electrode receiving a first reference voltage VREF1, and a second electrode connected to the third node N3. The sixth transistor T6 may be turned on in response to a first reset gate signal GR1 with a logic low level to provide the first reference voltage VREF1 to the third node N3. The sixth transistor T6 may be referred to as a first reset transistor.

The seventh transistor T7 may include a gate electrode receiving a bias gate signal GB, a first electrode receiving the initialization voltage VINT, and a second electrode connected to the fourth node N4. The seventh transistor T7 may be turned on in response to a bias gate signal GB with a logic low level to provide the initialization voltage VINT to the fourth node N4. The seventh transistor T7 may be referred to as an anode initialization transistor.

The eighth transistor T8 may include a gate electrode receiving a second reset gate signal GR2, a first electrode receiving a second reference voltage VREF2 different from the first reference voltage VREF1, and a second electrode connected to the third node N3. The eighth transistor T8 may be turned on in response to a second reset gate signal GR2 with a logic low level to provide the second reference voltage VREF2 to the third node N3. The eighth transistor T8 may be referred to as a second reset transistor.

The storage capacitor CST may include a first electrode connected to the third node N3 and a second electrode connected to the first node N1. The storage capacitor CST may store the data voltage VDATA provided to the third node N3 and may boost the voltage of the first node N1 based on a voltage provided to the third node N3.

The light emitting element EE may include an anode electrode connected to the fourth node N4 and a cathode electrode receiving a second power supply voltage ELVSS. The light emitting element EE may emit a light based on the driving current. As the magnitude of the driving current increases, a luminance corresponding to an emission intensity of the light emitting element EE may also increase.

As illustrated with reference to FIGS. 1 and 9, the pixel circuit PCb may sequentially perform a first compensation operation for a threshold voltage of the first transistor T1, a data write operation for the pixel circuit PCb, and a second compensation operation for the threshold voltage of the first transistor T1 using the first reference voltage VREF1 and the second reference voltage VREF2 different from the first reference voltage VREF1. Accordingly, the pixel circuit PCb may perform the first and second compensation operations for the threshold voltage VTH of the first transistor T1 with a single capacitor CST.

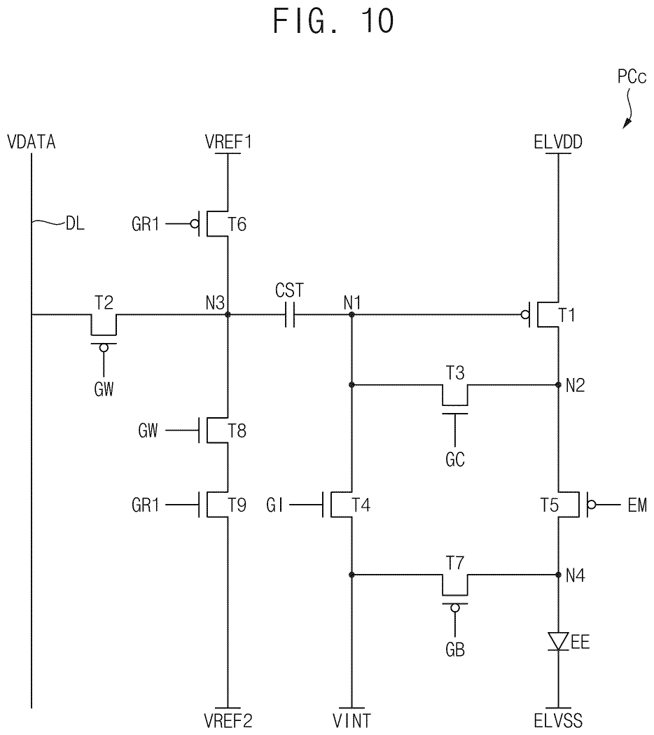

FIG. 10 is a circuit diagram showing an example PCc of a pixel circuit PC of a display panel 100 of FIG. 1.

Referring to FIGS. 1 to 10, a pixel circuit PCc may include a first transistor T1, a second transistor T2, a third transistor T3, a fourth transistor T4, a fifth transistor T5, a sixth transistor T6, and a seventh transistor T7. In an embodiment, the pixel circuit PCc may further include an eighth transistor T8 and a ninth transistor T9.

In an embodiment, the first transistor T1, the second transistor T2, the fifth transistor T5, the sixth transistor T6, and the seventh transistor T7 may be PMOS transistors, and the third transistor T3, the fourth transistor T4, the eighth transistor T8, and the ninth transistor T9 may be NMOS transistors.

The PMOS transistor may be turned on when an absolute value of a gate-source voltage of the PMOS transistor is greater than or equal to an absolute value of a threshold voltage of the PMOS transistor which is typically negative value. On the other hand, the PMOS transistor may be turned off when the absolute value of the gate-source voltage of the PMOS transistor is smaller than the absolute value of the threshold voltage of the PMOS transistor. For example, when a gate signal having a logic low level is applied to a gate electrode of the PMOS transistor, the PMOS transistor may be turned on and, when a gate signal with a logic high level is applied to the gate electrode of the PMOS transistor, the PMOS transistor may be turned off.

The NMOS transistor may be turned on when a gate-source voltage of the NMOS transistor is greater than or equal to the threshold voltage of the NMOS transistor which is typically positive value. On the other hand, the NMOS transistor may be turned off when the gate-source voltage of the NMOS transistor is lower than the threshold voltage of the NMOS transistor. For example, when a gate signal with a logic high level is applied to the gate electrode of the NMOS transistor, the NMOS transistor may be turned on. On the other hand, when a gate signal with a logic low level is applied to the gate electrode of the NMOS transistor, the NMOS transistor may be turned off.

The first transistor T1 may include a gate electrode connected to a first node N1, a first electrode receiving a first power supply voltage ELVDD, and a second electrode connected to a second node N2. The first transistor T1 may be turned on based on a voltage of the first node N1 and the first power supply voltage ELVDD to generate a driving current. Specifically, the first transistor T1 may generate the driving current based on a difference between the voltage of the first node N1 and the first power supply voltage ELVDD. More specifically, as the difference between the voltage of the first node N1 and the first power supply voltage ELVDD increases, a magnitude of the driving current may also increase. The first transistor T1 may be referred to as a driving transistor.

The second transistor T2 may include a gate electrode receiving a data write gate signal GW, a first electrode connected to a data line DL through which a data voltage VDATA is transmitted, and a second electrode connected to a third node N3. The second transistor T2 may be turned on in response to a data write gate signal GW with a logic low level to provide the data voltage VDATA to the third node N3. The second transistor T2 may be referred to as a data write transistor.

The third transistor T3 may include a gate electrode receiving a compensation gate signal GC, a first electrode connected to the first node N1, and a second electrode connected to the second node N2. The third transistor T3 may be turned on in response to a compensation gate signal GC with a logic high level to connect the first node N1 and the second node N2. Specifically, the third transistor T3 may be turned on in response to the compensation gate signal GC with a logic high level to diode-connect the first transistor T1. More specifically, the third transistor T3 may be turned on in response to the compensation gate signal GC with a logic high level to connect the gate electrode (e.g., the first node N1) and the drain electrode (e.g., the second node N2) of the first transistor T1 in a diode configuration. The third transistor T3 may be referred to as a compensation transistor.

The fourth transistor T4 may include a gate electrode receiving an initialization gate signal GI, a first electrode receiving an initialization voltage VINT, and a second electrode connected to the first node N1. The fourth transistor T4 may be turned on in response to an initialization gate signal GI with a logic high level to provide the initialization voltage VINT to the first node N1. The fourth transistor T4 may be referred to as an initialization transistor.

The fifth transistor T5 may include a gate electrode receiving an emission signal EM, a first electrode connected to the second node N2, and a second electrode connected to the fourth node N4. The fifth transistor T5 may be turned on in response to an emission signal EM with a logic low level to connect the second node N2 and the fourth node N4. When the fifth transistor T5 is turned on, the fifth transistor T5 may provide the driving current to the light emitting element EE. The fifth transistor T5 may be referred to as an emission control transistor.

The sixth transistor T6 may include a gate electrode receiving a first reset gate signal GR1, a first electrode receiving a first reference voltage VREF1, and a second electrode connected to the third node N3. The sixth transistor T6 may be turned on in response to a first reset gate signal GR1 with a logic low level to provide the first reference voltage VREF1 to the third node N3. The sixth transistor T6 may be referred to as a first reset transistor.

The seventh transistor T7 may include a gate electrode receiving a bias gate signal GB, a first electrode receiving the initialization voltage VINT, and a second electrode connected to the fourth node N4. The seventh transistor T7 may be turned on in response to a bias gate signal GB with a logic low level to provide the initialization voltage VINT to the fourth node N4. The seventh transistor T7 may be referred to as an anode initialization transistor.

The eighth transistor T8 may include a gate electrode receiving the data write gate signal GW, a first electrode, and a second electrode connected to the third node N3.

The ninth transistor T9 may include a gate electrode receiving the first reset gate signal GR1, a first electrode receiving a second reference voltage VREF2 different from the first reference voltage VREF, and a second electrode connected to the first electrode of the eighth transistor T8.

When the eighth transistor T8 is turned on in response to a data write gate signal GW with a logic high level and the ninth transistor T9 is turned on in response to a first reset gate signal GR1 with a logic high level, the eighth transistor T8 and the ninth transistor T9 may provide the second reference voltage VREF2 to the third node N3.

The eighth transistor T8 may be referred to as a second reset transistor, and the ninth transistor T9 may be referred to as a third reset transistor.

The storage capacitor CST may include a first electrode connected to the third node N3 and a second electrode connected to the first node N1. The storage capacitor CST may store the data voltage VDATA provided to the third node N3 and may boost the voltage of the first node N1 based on a voltage provided to the third node N3.

The light emitting element EE may include an anode electrode connected to the fourth node N4 and a cathode electrode receiving a second power supply voltage ELVSS. The light emitting element EE may emit a light based on the driving current. As the magnitude of the driving current increases, a luminance corresponding to an emission intensity of the light emitting element EE may also increase.

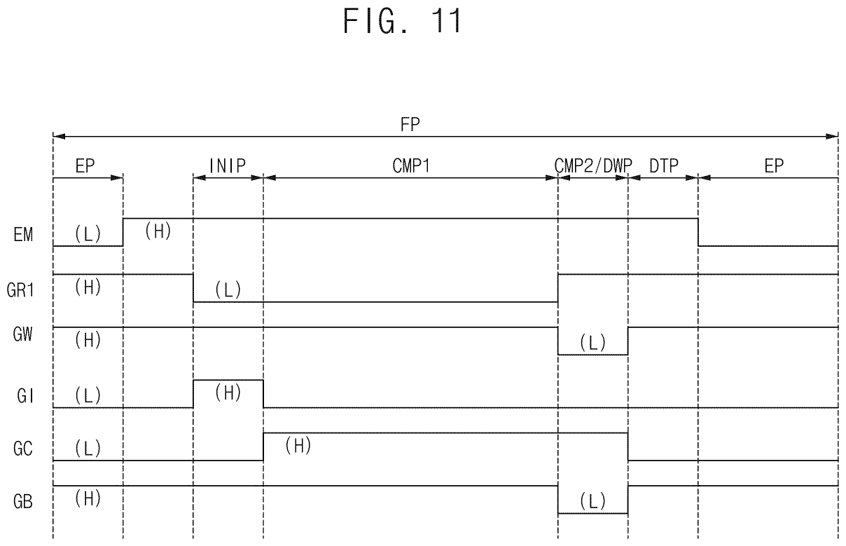

FIG. 11 is a timing diagram showing an example of an operation of a pixel circuit PCc of FIG. 10.

Referring to FIGS. 1 to 11, the pixel circuit PCc may operate on a frame-by-frame basis. A frame period FP of the pixel circuit PCc may include an initialization period INIP, a first compensation period CMP1, a second compensation/data write period CMP2/DWP, a data transmission period DTP, and an emission period EP.

In the initialization period INIP, the emission signal EM may be at the high level H, the first reset gate signal GR1 may be at the low level L, the data writing gate signal GW may be at the high level H, the initialization gate signal GI may be at the high level H, the compensation gate signal GC may be at the low level L, and the bias gate signal GB may be at the high level H.

During the first compensation period CMP1, the emission signal EM may be at the high level H, the first reset gate signal GR1 may be at the low level L, the data write gate signal GW may be at the high level H, the initialization gate signal GI may be at the low level L, the compensation gate signal GC may be at the high level H, and the bias gate signal GB may be at the high level H.

In the second compensation/data write period CMP2/DWP, the emission signal EM may be at the high level H, the first reset gate signal GR1 may be at the high level H, the data write gate signal GW may be at the low level L, the initialization gate signal GI may be at the low level L, the compensation gate signal GC may be at the high level H, and the bias gate signal GB may be at the low level L.

During the data transmission period DTP, the emission signal EM may be at the high level H, the first reset gate signal GR1 may be at the high level H, the data write gate signal GW may be at the high level H, the initialization gate signal GI may be at the low level L, the compensation gate signal GC may be at the low level L, and the bias gate signal GB may be at the high level H.

During the emission period EP, the emission signal EM may be at the low level L, the first reset gate signal GR1 may be at the high level H, the data write gate signal GW may be at the high level H, the initialization gate signal GI may be at the low level L, the compensation gate signal GC may be at the low level L, and the bias gate signal GB may be at the high level H.

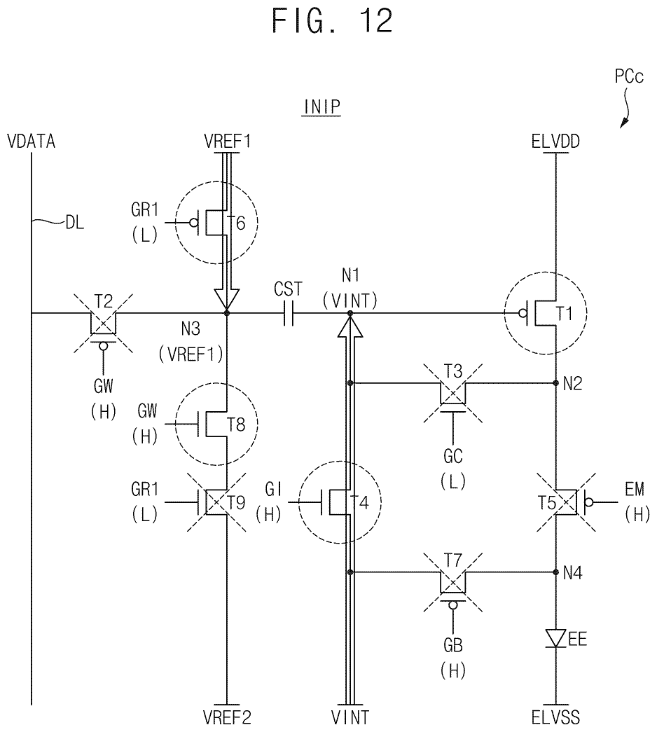

FIG. 12 is a circuit diagram showing an example of an operation of a pixel circuit PCc of FIG. 10 in an initialization period INIP of FIG. 11.

Referring to FIGS. 1 to 12, in the initialization period INIP, an initialization operation for the gate electrode of the first transistor T1 and an initialization operation for the storage capacitor CST may be performed.

In the initialization period INIP, the second transistor T2 may be turned off in response to the data write gate signal GW with the high level H, the third transistor T3 may be turned off in response to the compensation gate signal GC with the low level L, the fourth transistor T4 may be turned on in response to the initialization gate signal GI with the high level H, the fifth transistor T5 may be turned off in response to the emission signal EM with the high level H, the sixth transistor T6 may be turned on in response to the first reset gate signal GR1 with the low level L, the seventh transistor T7 may be turned off in response to the bias gate signal GB with the high level H, the eighth transistor T8 may be turned on in response to the data write gate signal GW with the high level H, and the ninth transistor T9 may be turned off in response to the first reset gate signal GR1 with the low level L.

As the fourth transistor T4 is turned on, the initialization voltage VINT may be supplied to the first node N1, thereby initializing the voltage of the first node N1 to the initialization voltage VINT. Accordingly, the voltage of the gate electrode of the first transistor T1 may be initialized to the initialization voltage VINT, and a voltage of the second electrode of the storage capacitor CST may be initialized to the initialization voltage VINT.

As the voltage of the gate electrode (i.e., the first node N1) of the first transistor T1 is initialized to the initialization voltage VINT (e.g., a logic low voltage) and a voltage of a source electrode (i.e., the first electrode) of the first transistor T1 is supplied with the first power supply voltage ELVDD, an absolute value of a gate-source voltage (i.e., “|VINT−ELVDD|”) of the first transistor T1 may be greater than or equal to an absolute value of the threshold voltage of the first transistor T1. Therefore, the first transistor T1 may be turned on.

As the sixth transistor T6 is turned on to provide the first reference voltage VREF1 to the third node N3, the voltage of the third node N3 may be set to the first reference voltage VREF1. Accordingly, a voltage of the first electrode of the storage capacitor CST may be set to the first reference voltage VREF1.

As a result of the initialization operation for the gate electrode of the first transistor T1 and the initialization operation for the storage capacitor CST during the initialization period INIP, the first N1 may be initialized to the initialization voltage VINT and the third node N3 may be set to the first reference voltage VREF1.

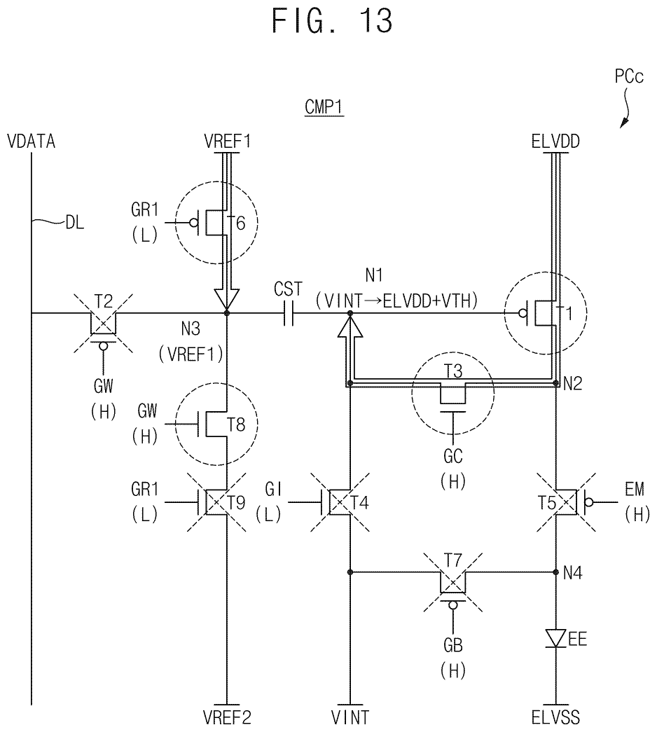

FIG. 13 is a circuit diagram showing an example of an operation of a pixel circuit PCc of FIG. 10 in a first compensation period CMP1 of FIG. 11.

Referring to FIGS. 1 to 13, in the first compensation period CMP1, a first compensation operation for the threshold voltage VTH of the first transistor T1 may be performed.

During the first compensation period CMP1, the second transistor T2 may be turned off in response to the data write gate signal GW with the high level H, the third transistor T3 may be turned on in response to the compensation gate signal GC with the high level H, the fourth transistor T4 may be turned off in response to the initialization gate signal GI with the low level L, the fifth transistor T5 may be turned off in response to the emission signal EM with the high level H, the sixth transistor T6 may be turned on in response to the first reset gate signal GR1 with the low level L, the seventh transistor T7 may be turned off in response to the bias gate signal GB with the high level H, the eighth transistor T8 may be turned on in response to the data write gate signal GW with the high level H, and the ninth transistor T9 may be turned off in response to the first reset gate signal GR1 with the low level L.

As the voltage of the gate electrode (i.e., the first node N1) of the first transistor T1 is set to the initialization voltage VINT (e.g., a logic low voltage), and the voltage of the source electrode (i.e., the first electrode) of the first transistor T1 is the first power supply voltage ELVDD, an absolute value of the gate-source voltage (i.e., “|VINT−ELVDD|”) of the first transistor T1 may be greater than or equal to an absolute value of the threshold voltage VTH of the first transistor T1. Therefore, the first transistor T1 may be turned on.

The third transistor T3 may be turned on to connect the first node N1 and the third node N3. Specifically, the third transistor T3 may be turned on to diode-connect the first transistor T1. More specifically, the third transistor T3 may be turned on in response to the compensation gate signal GC with the logic low level to connect the gate electrode (e.g., the first node N1) and the drain electrode (e.g., the second node N2) of the first transistor T1 in a diode configuration.

When both the first transistor T1 and the third transistor T3 are turned on, a current path is established through the first transistor T1 and the third transistor T3. As a result, the voltage of the first node N1 may transition from the initialization voltage VINT to a second voltage level determined by the current flow through the current path. The second voltage level may correspond to the first power supply voltage ELVDD minus the absolute value of the threshold voltage VTH of the first transistor T1 (i.e., “ELVDD−|VTH|”).

As a result of the turning on both the first transistor T1 and the third transistor T3 for connecting the first transistor T1 in a diode configuration during the first compensation period CMP1, the first transistor T1 is connected in a diode configuration, and the storage capacitor CST may store the second voltage level (i.e., “ELVDD−|VTH|”) at the second electrode of the storage capacitor CST, thereby tracking the variation in the threshold voltage VTH of the first transistor T1. Accordingly, the first compensation operation for compensating the threshold voltage variation of the first transistor T1 may be performed.

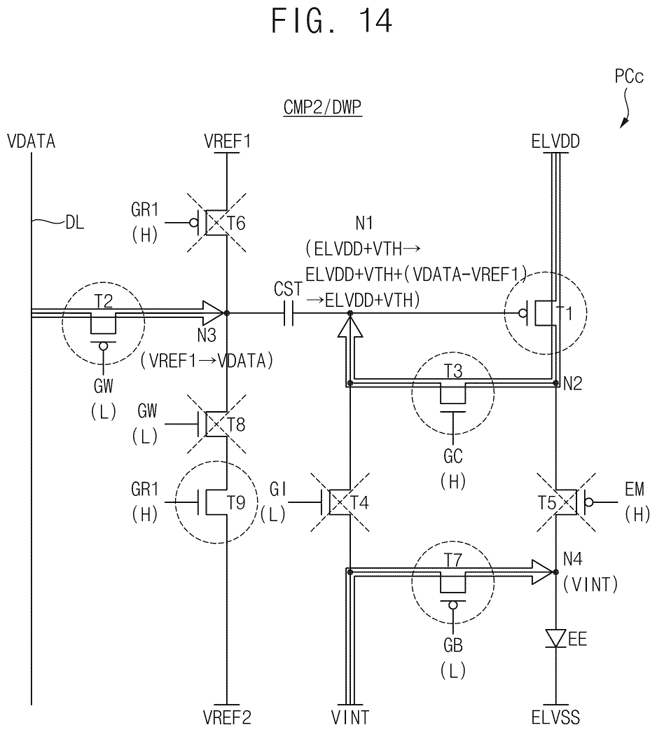

FIG. 14 is a circuit diagram showing an example of an operation of a pixel circuit PCc of FIG. 10 in a second compensation/data write period CMP2/DWP of FIG. 11.

Referring to FIGS. 1 to 6, in the second compensation/data write period CMP2/DWP, a second compensation operation for the threshold voltage VTH of the first transistor T1, a data write operation for the pixel circuit PCc, and an anode initialization operation for the light emitting element EE may be performed.

During the second compensation/data write period CMP2/DWP, the second transistor T2 may be turned on in response to the data write gate signal GW with the low level L, the third transistor T3 may be turned on in response to the compensation gate signal GC with the high level H, the fourth transistor T4 may be turned off in response to the initialization gate signal GI with the low level L, the fifth transistor T5 may be turned off in response to the emission signal EM with the high level H, the sixth transistor T6 may be turned off in response to the first reset gate signal GR1 with the high level H, the seventh transistor T7 may be turned on in response to the bias gate signal GB with the low level L, the eighth transistor T8 may be turned off in response to the data write gate signal GW with the low level L, and the ninth transistor T9 may be turned on in response to the first reset gate signal GR1 with the high level H.

As the second transistor T2 is turned on, the data voltage VDATA transmitted through the data line DL may be applied to the third node N3. Therefore, the voltage of the third node N3 may transition from the first reference voltage VREF1 to the data voltage VDATA, causing voltage change at the third node N3 by an amount equal to a difference between the data voltage VDATA and the first reference voltage VREF1 (i.e., “VDATA−VREF1”).

In response to the voltage change at the third node N3, the storage capacitor CST may boost the voltage of the first node N1 in proportion to the voltage change at the third node N3. Therefore, when the voltage at the third node N3 changes by an amount equal to the difference between the data voltage VDATA and the first reference voltage VREF1 (i.e., “VDATA−VREF1”), the storage capacitor CST may boost the voltage of the first node N1 by the same amount. Accordingly, the voltage of the first node N1 may be boosted by the amount equal to the difference between the data voltage VDATA and the first reference voltage VREF1 (i.e., “VDATA−VREF1”), causing voltage level of the first node N1 to transition from the first power supply voltage ELVDD minus the threshold voltage VTH of the first transistor T1 (i.e., “ELVDD−|VTH|”) to “ELVDD−|VTH|+(VDATA−VREF1)”.

As a result, the gate-source voltage of the first transistor T1 may be changed to “ELVDD−|VTH|+(VDATA−VREF1)−ELVDD” (i.e., “VTH+VDATA−VREF1”). The compensation operation for the threshold voltage VTH of the first transistor T1 may be performed when the first transistor T1 should is turned on. The first transistor T1 may be turned on when the gate-source voltage (i.e., “VTH+VDATA−VREF1”) of the first transistor T1 is lower than or equal to the threshold voltage VTH of the first transistor T1 (i.e., VTH+VDATA−VREF1≤VTH). Therefore, the first transistor T1 may be turned on when the first reference voltage VREF1 is greater than or equal to the data voltage VDATA (i.e., VDATA≤VREF1). Because the data voltage VDATA may vary according to a grayscale of the input image data IMG, the first reference voltage VREF1 may be set to have a value greater than or equal to a maximum value of the data voltage VDATA. The maximum value of the data voltage VDATA may correspond to a maximum grayscale of the input image data IMG.

The third transistor T3 may be turned on to connect the first node N1 and the third node N3. When the third transistor T3 is turned on to diode-connect the first transistor T1.

When both the first transistor T1 and the third transistor T3 are turned on, the voltage of the first node N1 may change from “ELVDD−|VTH|+(VDATA−VREF1)” to the first power supply voltage ELVDD minus the absolute value of the threshold voltage VTH of the first transistor T1 (i.e., “ELVDD−|VTH|”).

When the seventh transistor T7 is turned on, the initialization voltage VINT may be supplied to the fourth node N4. Therefore, the voltage of the fourth node N4 may be set to the initialization voltage VINT. Accordingly, the anode electrode of the light emitting element EE may be initialized to the initialization voltage VINT.

As a result, in the second compensation/data write period CMP2/DWP, when the first transistor T1 is turned on and the third transistor T3 is turned on to diode-connect the first transistor T1, the storage capacitor CST may store a voltage level at its second electrode reflecting variation in the threshold voltage VTH of the first transistor T1 (i.e., “ELVDD−|VTH|”), thereby tracking the threshold voltage VTH variation of the first transistor T1. Therefore, the second compensation operation for the threshold voltage VTH of the first transistor T1 may be performed. In addition, when the second transistor T2 is turned on, and the data voltage VDATA transmitted through the data line DL is provided to the third node N3, the storage capacitor CST may store the data voltage VDATA at its first electrode. Therefore, the data write operation for the pixel circuit PCa may be performed. In addition, the anode initialization operation for the light emitting element EE may be performed.

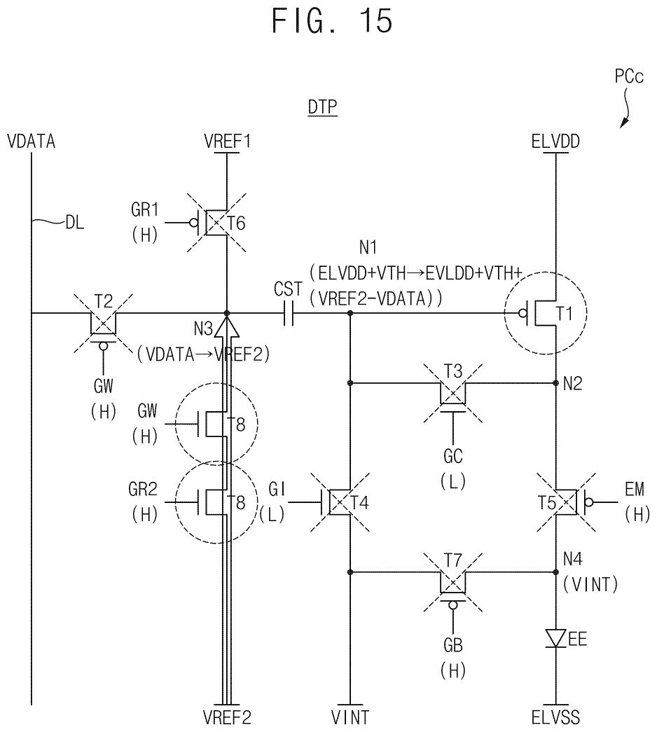

FIG. 15 is a circuit diagram showing an example of an operation of a pixel circuit PCc of FIG. 10 in a data transmission period DTP of FIG. 11.

Referring to FIGS. 1 to 15, a data transmission operation may be performed in the data transmission period DTP.

During the data transmission period DTP, the second transistor T2 may be turned off in response to the data write gate signal GW with the high level H, the third transistor T3 may be turned off in response to the compensation gate signal GC with the low level L, the fourth transistor T4 may be turned off in response to the initialization gate signal GI with the low level L, the fifth transistor T5 may be turned off in response to the emission signal EM with the high level H, the sixth transistor T6 may be turned off in response to the first reset gate signal GR1 with the high level H, the seventh transistor T7 may be turned off in response to the bias gate signal GB with the high level H, the eighth transistor T8 may be turned off in response to the data write gate signal GW with the high level H, and the ninth transistor T9 may be turned on in response to the first reset gate signal GR1 with the high level H.

The eighth transistor T8 and the ninth transistor T9 may be turned on to provide the second reference voltage VREF2 to the third node N3. Therefore, the voltage of the third node N3 may transition from the data voltage VDATA to the second reference voltage VREF2, causing a voltage change at the third node N3 by an amount equal to a difference between the second reference voltage VREF2 and the data voltage VDATA (i.e., “VREF2−VDATA”).

When the voltage at the third node N3 is changed to the second reference voltage VREF2, the storage capacitor CST may boost the voltage of the first node N1 in response to the voltage change at the third node N3. Therefore, when the voltage at the third node N3 may be changed by an amount equal to the difference between the second reference voltage VREF2 and the data voltage VDATA (i.e., “VREF2−VDATA”), the storage capacitor CST may boost the voltage of the first node N1 by the same amount. Accordingly, the voltage of the first node N1 may be boosted by an amount equal to the difference between the second reference voltage VREF2 and the data voltage VDATA (i.e., “VREF2−VDATA”) from the first power supply voltage ELVDD minus the threshold voltage VTH of the first transistor T1 (i.e., “ELVDD−|VTH|”) to “ELVDD−|VTH|+(VREF2−VDATA)”.

As a result, the gate-source voltage of the first transistor T1 may be changed to “ELVDD+VTH+(VREF2−VDATA)−ELVDD” (i.e., “VTH+VREF2−VDATA”). The first transistor T1 may generate the driving current in the emission period EP when the first transistor T1 is turned on. The first transistor T1 may be turned on when the gate-source voltage (i.e., “VTH+VREF2−VDATA”) of the first transistor T1 is lower than or equal to the threshold voltage VTH of the first transistor T1 (i.e., VTH+VREF2−VDATA≤VTH). Therefore, the second reference voltage VREF2 is lower than or equal to the data voltage VDATA (i.e., VREF2≤VDATA). Because the data voltage VDATA may vary according to the grayscale of the input image data IMG, the second reference voltage VREF2 may be lower than or equal to the maximum value of the data voltage VDATA. For example, the maximum value of the data voltage VDATA may correspond to the maximum grayscale of the input image data IMG.

In the data transmission period DTP, when the eighth transistor T8 and the ninth transistor T9 are turned on to provide the second reference voltage VREF2 to the third node N3, and the voltage of the third node N3 may be changed from the data voltage VDATA to the second reference voltage VREF2 by an amount equal to the difference between the second reference voltage VREF2 and the data voltage VDATA (i.e., “VREF2−VDATA”), and the storage capacitor CST may correspondingly boost the voltage of the first node N1 by the same amount. Accordingly, the data voltage VDATA may be transmitted from the third node N3 to the first node N1, and the data transmission operation may be performed.

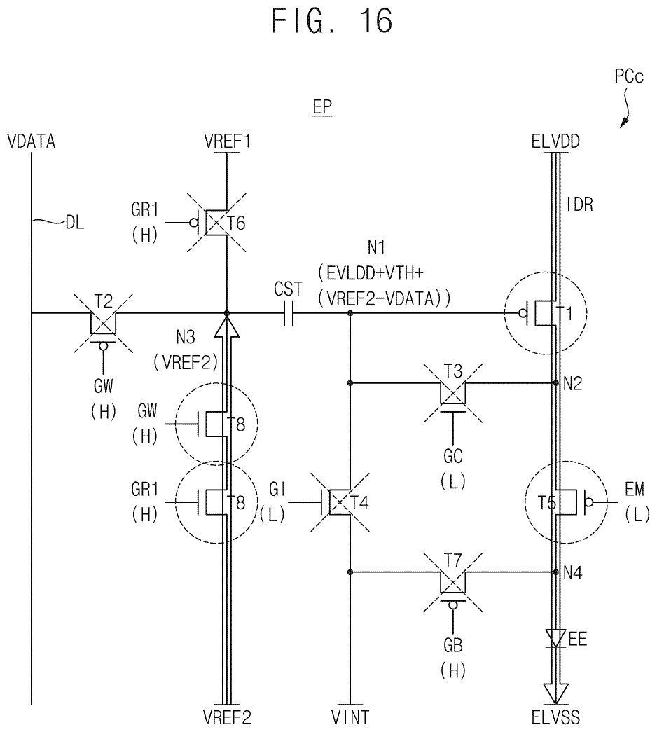

FIG. 16 is a circuit diagram showing an example of an operation of a pixel circuit PCc of FIG. 10 in an emission period EP of FIG. 11.

Referring to FIGS. 1 to 8, in the emission period EP, an emission operation for the light emitting element EE may be performed.

In the emission period EP, the second transistor T2 may be turned off in response to the data write gate signal GW with the high level H, the third transistor T3 may be turned off in response to the compensation gate signal GC with the low level L, the fourth transistor T4 may be turned off in response to the initialization gate signal GI with the low level L, the fifth transistor T5 may be turned on in response to the emission signal EM with the low level L, the sixth transistor T6 may be turned off in response to the first reset gate signal GR1 with the high level H, the seventh transistor T7 may be turned off in response to the bias gate signal GB with the high level H, the eighth transistor T8 may be turned on in response to the high The data write gate signal GW with a level H may be turned on in response to the data write gate signal GW with the high level H, and the ninth transistor T9 may be turned on in response to the first reset gate signal GR1 with the high level H.

As the eighth transistor T8 and the ninth transistor T9 are turned on, the second reference voltage VREF2 is supplied to the third node N3. Therefore, the voltage of the third node N3 may remain at the second reference voltage VREF2.

The first transistor T1 may be turned on based on the voltage of the first node N1 and the first power supply voltage ELVDD to generate the driving current IDR. Specifically, the first transistor T1 may generate the driving current IDR based on the difference (i.e., “VTH+(VREF2−VDATA)”) between the voltage of the first node N1 (i.e., “ELVDD+VTH+(VREF2−VDATA)”) and the first power supply voltage ELVDD. The data voltage VDATA may change the difference between the voltage of the first node N1 and the first power supply voltage ELVDD, thereby varying the magnitude of the driving current IDR according to the data voltage VDATA.

Since the fifth transistor T5 as well as the first transistor T1 are turned on, a current path e for the driving current IDR may be established between the first power supply voltage ELVDD and the second power supply voltage ELVSS across the light emitting element EE.

Accordingly, the driving current IDR may flow through the light emitting element EE along the current path established for the driving current IDR. The light emitting element EE may emit the light in a luminance proportional to the driving current IDR. As the magnitude of the driving current IDR increases, the luminance corresponding to the emission intensity of the light emitting element EE may also increase.

Accordingly, an emission operation may be performed for the light emitting element EE in the emission period EP.

As illustrated with reference to FIGS. 11 to 16, the pixel circuit PCc may sequentially perform the first compensation operation for the threshold voltage VTH of the first transistor T1, the data write operation for the pixel circuit PCc, and the second compensation operation for the threshold voltage VTH of the first transistor T1 using the first reference voltage VREF1 and the second reference voltage VREF2 different from the first reference voltage VREF1. Accordingly, the pixel circuit PCc may perform the first and second compensation operations for the threshold voltage VTH of the first transistor T1 with a single capacitor CST.

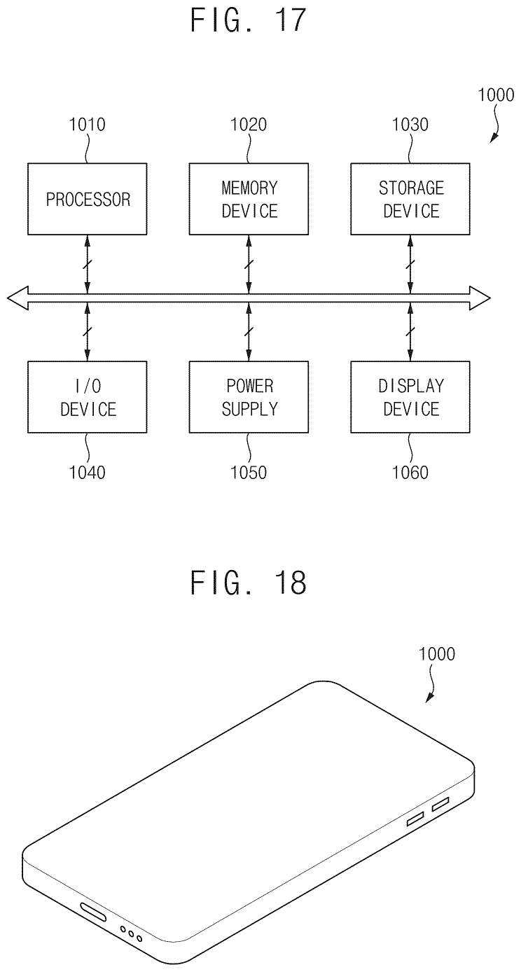

FIG. 17 is a block diagram showing an electronic device 1000 according to an embodiment of the present inventive concept. FIG. 18 is a diagram showing an example in which an electronic device 1000 of FIG. 17 is implemented as a smart phone.

Referring to FIGS. 1 to 18, the electronic device 1000 may include a processor 1010, a memory device 1020, a storage device 1030, an input/output (I/O) device 1040, a power supply 1050 and a display device 1060. Here, the display device 1060 may be the display device of FIG. 1. In addition, the electronic device 1000 may further include a plurality of ports for communicating with a video card, a sound card, a memory card, a universal serial bus (USB) device, other electronic devices, etc.

In an embodiment, as shown in FIG. 18, the electronic device 1000 may be implemented as a smart phone. However, the electronic device 1000 is not limited thereto. For example, the electronic device 1000 may be implemented as a cellular phone, a video phone, a smart pad, a smart watch, a tablet PC, a car navigation system, a computer monitor, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic device 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magneto-resistive random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display device 1060 may be included in the I/O device 1040. The power supply 1050 may provide power for operations of the electronic device 1000. The display device 1060 may be coupled to other components via the buses or other communication links.

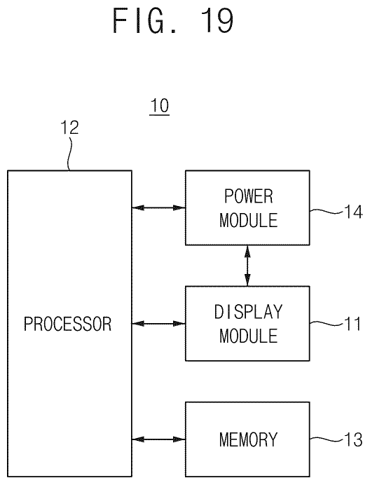

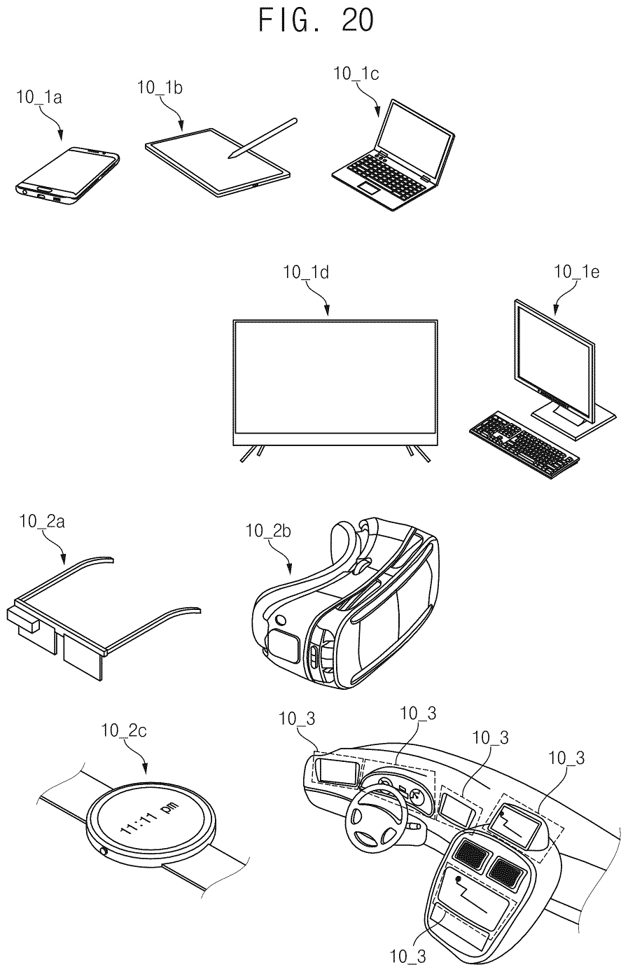

FIG. 19 is a block diagram showing an electronic device 10 according to an embodiment of the present inventive concept. FIG. 20 is schematic diagrams showing the electronic devices of FIG. 19.

Referring to FIG. 19, the electronic device 10 according to an embodiment may include a display module 11, a processor 12, a memory 13 and a power module 14.

The display device according to the embodiment of the present inventive concept may be applied to various electronic devices.

In an embodiment, the electronic device 10 may include the display device of FIG. 1. An operation of the display device included in the electronic device 10 may be the same as the operation of the display device explained referring to FIGS. 1 to 16. The electronic device 10 may further include a module or a device having additional functions in addition to the display device.

The processor 12 may include at least one of a central processing unit (CPU), an application processor (AP), a graphic processing unit (GPU), a communication processor (CP), an image signal processor (ISP) and a controller.

In an embodiment, the processor 12 may provide the input control signal CONT of FIG. 1 and the input image data IMG of FIG. 1 to the driving controller 200 included in the display device of FIG. 1. The processor is configured to control the driving controller 200 to perform a first compensation operation for the threshold voltage variation of the first transistor of the pixel circuit of FIG. 1 by initializing the third node and thereafter providing the first reference voltage VREF1 to the third node, and to perform a second compensation operation by providing the data voltage to the third node and thereafter providing the second reference voltage VREF2 to the third node

In an embodiment, the processor 12 may be divided into two or more in a functional or structural perspective. For example, the processor 12 may include a main processor, which is a first driving chip type, including the central processing unit and an auxiliary processor, which is a second driving chip type, including a controller receiving an image signal from the main processor and processing the image signal to match interface specifications of the display module 11. For example, the auxiliary processor may include the driving controller 200 included in the display device of FIG. 1. Thus, the main processor may provide the input control signal CONT of the FIG. 1 and the input image data IMG of FIG. 1 to the auxiliary processor. The auxiliary processor may process the image signal based on the input control signal CONT and the input image data IMG.

The memory 13 may include at least one of a nonvolatile memory and a volatile memory. Data information required for the operation of the processor 12 or the display module 11 may be stored in the memory 13. When the processor 12 executes an application stored in the memory 13, the input control signal CONT and/or the input image data IMG may be transmitted to the display module 11 and the display module 11 may process the input control signal CONT and/or the input image data IMG and may output image information through a display area.

The power module 14 may include a power supply module, such as a power adapter or a battery device, and a power conversion module converting power supplied by the power supply module to generate a power required for the operation of the electronic device 10.

At least one of the elements of the electronic device 10 may be included in the display device according to embodiments of the present inventive concept. In addition, a part of a single functional module may be included in the display device and another part of the single functional module may be disposed out of the display device. For example, the display module 11 may be included in the display device but the processor 12, the memory 13 and the power module 14 may be included in another device in the electronic device 10 which is not the display device.

Referring to FIG. 20, the various electronic devices including the display device according to the present embodiments may include electronic devices for displaying image such as a smartphone 10_1a, a tablet PC 10_1b, a laptop 10_1c, a television 10_1d, a desktop monitor 10_1e, wearable electronic devices including a display module such as smart glasses 10_2a, a head mounted display 10_2b and a smart watch 10_2c and vehicle electronic devices 10_3 including display modules such as a CID (center information display), a room mirror display disposed on an instrument panel, center fascia, and a dashboard of a vehicle. The electronic device 10 may not be limited to the electronic devices for displaying image, the wearable electronic devices and the vehicle electronic devices 10_3.

According to the driver, the display device including the driver and the electronic device including the driver of the present embodiment as explained above, the power consumption of the display device may be reduced.

The foregoing is illustrative of the present inventive concept and is not to be construed as limiting thereof. Although a few example embodiments of the present inventive concept have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific example embodiments disclosed, and that modifications to the disclosed example embodiments, as well as other example embodiments, are intended to be included within the scope of the appended claims. The present inventive concept is defined by the following claims, with equivalents of the claims to be included therein.

What is claimed is:

1. A pixel circuit, comprising:
a first transistor including a gate electrode connected to a first node, a first electrode connected to a first power supply voltage, and a second electrode connected to a second node;
a second transistor including a gate electrode configured to receive a data write gate signal, a first electrode connected to a data line and configured to receive a data voltage through the data line, and a second electrode connected to a third node;
a third transistor including a gate electrode configured to receive a compensation gate signal, a first electrode connected to the first node, and a second electrode connected to the second node;
a fourth transistor including a gate electrode configured to receive an initialization gate signal, a first electrode connected to an initialization voltage, and a second electrode connected to the first node;
a fifth transistor including a gate electrode configured to receive an emission signal, a first electrode connected to the second node, and a second electrode connected to a fourth node;
a sixth transistor including a gate electrode configured to receive a first reset gate signal, a first electrode connected to a first reference voltage, and a second electrode connected to the third node;
a seventh transistor including a gate electrode configured to receive a bias gate signal, a first electrode connected to the initialization voltage, and a second electrode connected to the fourth node;
a storage capacitor including a first electrode connected to the third node and a second electrode connected to the first node; and
a light emitting element including an anode electrode connected to the fourth node and a cathode electrode connected to a second power supply voltage.

2. The pixel circuit of claim 1, wherein the first reference voltage is greater than or equal to a maximum value of the data voltage.

3. The pixel circuit of claim 1, wherein the pixel circuit further includes an eighth transistor including a gate electrode configured to receive a second reset gate signal, a first electrode connected to a second reference voltage different from the first reference voltage, and a second electrode connected to the third node.

4. The pixel circuit of claim 3, wherein the second reference voltage is lower than or equal to a maximum value of the data voltage.

5. The pixel circuit of claim 3, wherein the first transistor, the second transistor, the third transistor, the fourth transistor, the fifth transistor, the sixth transistor, the seventh transistor, and the eighth transistor are PMOS transistors.

6. The pixel circuit of claim 3, wherein the first transistor, the second transistor, the fifth transistor, the sixth transistor, the seventh transistor, and the eighth transistor are PMOS transistors, and the third transistor and the fourth transistor are NMOS transistors.

7. The pixel circuit of claim 3, wherein, in an initialization period, the fourth transistor is configured to be turned on to provide the initialization voltage to the first node, and the sixth transistor is configured to be turned on to provide the first reference voltage to the third node.

8. The pixel circuit of claim 7, wherein, in a first compensation period following the initialization period, the third transistor is configured to be turned on to diode-connect the first transistor, and the sixth transistor is configured to be turned on to provide the first reference voltage to the third node.

9. The pixel circuit of claim 8, wherein, in a second compensation/data write period following the first compensation period, the second transistor is configured to be turned on to provide the data voltage transmitted through the data line to the third node, the third transistor is configured to be turned on to diode-connect the first transistor, and the seventh transistor is configured to be turned on to provide the initialization voltage to the fourth node.

10. The pixel circuit of claim 9, wherein, in a data transmission period following the second compensation/data write period, the eighth transistor is configured to be turned on to provide the second reference voltage to the third node.

11. The pixel circuit of claim 10, wherein, in an emission period following the data transmission period, the first transistor is configured to be turned on based on a voltage of the first node and the first power supply voltage to generate a driving current, and the first transistor and the fifth transistor are configured to be turned on to provide the driving current to the light emitting element.

12. The pixel circuit of claim 1, wherein the pixel circuit further includes an eighth transistor and a ninth transistor, wherein the eighth transistor includes a gate electrode configured to receive the data write gate signal, a first electrode connected to a second electrode of the ninth transistor, and a second electrode connected to the third node, and a ninth transistor includes a gate electrode configured to receive the first reset gate signal, a first electrode configured to receive a second reference voltage different from the first reference voltage, and the second electrode connected to the first electrode of the eighth transistor.

13. The pixel circuit of claim 12, wherein the second reference voltage is lower than or equal to a maximum value of the data voltage.

14. The pixel circuit of claim 12, wherein the first transistor, the second transistor, the fifth transistor, the sixth transistor, and the seventh transistor are PMOS transistors, and the third transistor, the fourth transistor, the eighth transistor, and the ninth transistor are NMOS transistors.

15. The pixel circuit of claim 12, wherein, in an initialization period, the fourth transistor is configured to be turned on to provide the initialization voltage to the first node, and the sixth transistor is configured to be turned on to provide the first reference voltage to the third node.

16. The pixel circuit of claim 15, wherein, in a first compensation period following the initialization period, the third transistor is configured to be turned on to diode-connect the first transistor, and the sixth transistor is configured to be turned on to provide the first reference voltage to the third node.

17. The pixel circuit of claim 16, wherein, in a second compensation/data write period following the first compensation period, the second transistor is configured to be turned on to provide the data voltage transmitted through the data line to the third node, the third transistor is configured to be turned on to diode-connect the first transistor, and the seventh transistor is configured to be turned on to provide the initialization voltage to the fourth node, and in a data transmission period following the second compensation/data write period, the eighth transistor and the ninth transistor are configured to be turned on to provide the second reference voltage to the third node.

18. A display device, comprising:
a display panel including a pixel circuit; and
a display panel driver configured to drive the display panel,
wherein the pixel circuit includes:
a first transistor including a gate electrode connected to a first node, a first electrode connected to a first power supply voltage, and a second electrode connected to a second node;
a second transistor including a gate electrode configured to receive a data write gate signal, a first electrode connected to a data line and configured to receive a data voltage transmitted through the data line, and a second electrode connected to a third node;
a third transistor including a gate electrode configured to receive a compensation gate signal, a first electrode connected to the first node, and a second electrode connected to the second node;
a fourth transistor including a gate electrode configured to receive an initialization gate signal, a first electrode connected to an initialization voltage, and a second electrode connected to the first node;
a fifth transistor including a gate electrode configured to receive an emission signal, a first electrode connected to the second node, and a second electrode connected to a fourth node;
a sixth transistor including a gate electrode configured to receive a first reset gate signal, a first electrode connected to a first reference voltage, and a second electrode connected to the third node;
a seventh transistor including a gate electrode configured to receive a bias gate signal, a first electrode connected to the initialization voltage, and a second electrode connected to the fourth node;
a storage capacitor including a first electrode connected to the third node and a second electrode connected to the first node; and
a light emitting element including an anode electrode connected to the fourth node and a cathode electrode connected to a second power supply voltage.

19. An electronic device, comprising:
a display panel including a pixel circuit;
a display panel driver configured to drive the display panel; and
a processor configured to control the display panel driver,
wherein the pixel circuit includes:
a first transistor including a gate electrode connected to a first node, a first electrode connected to a first power supply voltage, and a second electrode connected to a second node;
a second transistor including a gate electrode configured to receive a data write gate signal, a first electrode connected to a data line and configured to receive a data voltage transmitted through the data line, and a second electrode connected to a third node;
a third transistor including a gate electrode configured to receive a compensation gate signal, a first electrode connected to the first node, and a second electrode connected to the second node;
a fourth transistor including a gate electrode configured to receive an initialization gate signal, a first electrode connected to an initialization voltage, and a second electrode connected to the first node;
a fifth transistor including a gate electrode configured to receive an emission signal, a first electrode connected to the second node, and a second electrode connected to a fourth node;
a sixth transistor including a gate electrode configured to receive a first reset gate signal, a first electrode connected to a first reference voltage, and a second electrode connected to the third node;
a seventh transistor including a gate electrode configured to receive a bias gate signal, a first electrode connected to the initialization voltage, and a second electrode connected to the fourth node;
an eighth transistor including a gate electrode configured to receive a second reset gate signal, a first electrode connected to a second reference voltage different from the first reference voltage, and a second electrode connected to the third node;
a storage capacitor including a first electrode connected to the third node and a second electrode connected to the first node; and
a light emitting element including an anode electrode connected to the fourth node and a cathode electrode connected to a second power supply voltage.

20. The electronic device of claim 19, wherein the processor is configured to control the display panel driver to perform a first compensation operation for compensating threshold voltage variation of the first transistor by initializing the third node to the initialization voltage and thereafter providing the first reference voltage to the third node, and to perform a second compensation operation by providing the data voltage to the third node and thereafter providing the second reference voltage to the third node.
